(19) United States
(12) Patent Application Publication
(10) Pub. No.: US 2025/0238867 A1
(43) Pub. Date: Jul. 24, 2025

(54) EVALUATING INVESTMENT PORTFOLIOS BASED ON THEMATIC CONCEPTS

(71) Applicant: Noonum, Inc., Redmond, WA (US)

(72) Inventors: Balaji Bandaru Shyamkumar, Sammamish, WA (US); Ho Yin Leo Leung, Redmond, WA (US); Cechi Shi, Kirkland, WA (US); Shankar Vaidyanathan, Redmond, WA (US)

(21) Appl. No.: 18/420,566

(22) Filed: Jan. 23, 2024

(51) Int. Cl. G06Q 40/06

(52) U.S. Cl. CPC G06Q 40/06

(57) ABSTRACT

Investment portfolios are evaluated based on thematic concepts. Natural language processing may be employed to determine thematic mentions of concepts in publications. Thematic scores associated with the organizations may be generated based on the thematic mentions and publication weights. Thematic models may be determined based on the organizations and performance outcomes such that each thematic model may predict a performance outcome based on the thematic scores associated with the organizations. Thematic models may be employed to predict the predicted outcomes for the organizations based on the thematic scores such that the predicted outcomes may be displayed in a report.

### TECHNICAL FIELD

The present invention relates generally to data management, and more particularly, but not exclusively, to evaluating investment portfolios.

### BACKGROUND

Contemporary institutional or retail investors are afforded many conventional financial metrics with which to evaluate investment opportunities. However, other factors, both foreseen or unforeseen may have significant impacts on the performance of organizations or groups of organizations. While many conventional financial metrics may be provided in well-known formats or otherwise may be readily available to both institutional investors or retail investors, they may not reflect other important factors associated with the actual performance or operation of organizations. For example, many publications may report on various activities or initiatives associated with organizations. In many cases, it may not be obvious how these activities or initiatives may impact organization performance outcomes even though they may have significant influence or correlation with one or more performance outcomes. Thus, it is with respect to these considerations and others that the present invention has been made.

### BRIEF DESCRIPTION OF THE DRAWINGS

Non-limiting and non-exhaustive embodiments of the present innovations are described with reference to the following drawings. In the drawings, like reference numerals refer to like parts throughout the various figures unless otherwise specified. For a better understanding of the described innovations, reference will be made to the following Detailed Description of Various Embodiments, which is to be read in association with the accompanying drawings, wherein:

FIG. 1 illustrates a system environment in which various embodiments may be implemented;

FIG. 2 illustrates a schematic embodiment of a client computer;

FIG. 3 illustrates a schematic embodiment of a network computer;

FIG. 4 illustrates a logical architecture of a portion of a portfolio platform for evaluating investment portfolios based on thematic concepts in accordance with one or more of the various embodiments;

FIG. 5 illustrates a logical schematic of a system for evaluating investment portfolios based on thematic concepts in accordance with one or more of the various embodiments;

FIG. 6 illustrates a logical schematic of a thematic signature data structure for evaluating investment portfolios based on thematic concepts in accordance with one or more of the various embodiments;

FIG. 7 illustrates an overview flowchart for a process for evaluating investment portfolios based on thematic concepts in accordance with one or more of the various embodiments;

FIG. 8 illustrates a flowchart for a process for evaluating investment portfolios based on thematic concepts in accordance with one or more of the various embodiments;

FIG. 9 illustrates a flowchart for a process for evaluating investment portfolios based on thematic concepts in accordance with one or more of the various embodiments;

FIG. 10 illustrates a flowchart for a process for generating thematic impact models for evaluating investment portfolios based on thematic concepts in accordance with one or more of the various embodiments; and

FIG. 11 illustrates a flowchart for a process for evaluating investment portfolios based on thematic concepts in accordance with one or more of the various embodiments.

### DETAILED DESCRIPTION OF VARIOUS EMBODIMENTS

Various embodiments now will be described more fully hereinafter with reference to the accompanying drawings, which form a part hereof, and which show, by way of illustration, specific exemplary embodiments by which the invention may be practiced. The embodiments may, however, be embodied in many different forms and should not be construed as limited to the embodiments set forth herein; rather, these embodiments are provided so that this disclosure will be thorough and complete, and will fully convey the scope of the embodiments to those skilled in the art. Among other things, the various embodiments may be methods, systems, media or devices. Accordingly, the various embodiments may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

For example, embodiments, the following terms are also used herein according to the corresponding meaning, unless the context clearly dictates otherwise.

As used herein the term, “engine” refers to logic embodied in hardware or software instructions, which can be written in a programming language, such as C, C++, Objective-C, COBOL, Java™, PHP, Perl, JavaScript, Ruby, VBScript, Microsoft.NET™ languages such as C#, or the like. An engine may be compiled into executable programs or written in interpreted programming languages. Software engines may be callable from other engines or from themselves. Engines described herein refer to one or more logical modules that can be merged with other engines or applications, or can be divided into sub-engines. The engines can be stored in non-transitory computer-readable medium or computer storage device and be stored on and executed by one or more general purpose computers, thus creating a special purpose computer configured to provide the engine.

As used herein the term “data source” refers to a service, system, or facility that may provide data to a data ingestion platform. Data sources may be local (e.g., on premises databases, reachable via a local area network, or the like) or remote (e.g., reachable over a wide-area network, remote endpoints, or the like). In some cases, data sources may be streams that provide continuous or intermittent flows of data to a data ingestion platform. Further, in some cases, data sources may be local or remote file systems, document management systems, cloud-based storage, or the like. Data sources may support one or more conventional or customer communication or data transfer protocols, such as, TCP/IP, HTTP, FTP, SFTP, SCP, RTP, or the like. In some cases, data sources may be owned, managed, or operated by various organizations that may provide data to a data ingestion platform. In some instances, data sources may be public or private websites or other public or private repositories that enable third parties to access hosted content.

As used herein the terms “organization,” or “entity” refer to the various businesses, companies, associations, institutions, partnerships, states, agencies, or the like, that may be analyzed or evaluated based on thematic scores, or the like.

As used herein the term “theme” refers to a high-level concept that encompasses one or more lower-level concepts. In some cases, themes may refer to areas of technology, industry domains, social structures, or the like. Examples of themes may include 5G telecommunications, petroleum, green energy, sustainability, medicine, elder care, or the like. In some cases, a concept may be associated with more than one theme.

As used herein the terms “thematic score,” or “thematic impact score” refer to one or more data structures that include data or metadata that quantify how closely one or more organizations correlate with concepts or themes.

As used herein the term “scoring model” refers to one or more data structures that encapsulate the data, rules, machine learning models, machine learning classifiers, or instructions that may be employed to generate thematic scores for organizations or portfolios.

As used herein the terms “thematic impact model,” or “thematic model” refer to one or more data structures that encapsulate the data, rules, coefficients, parameters, machine learning models, machine learning classifiers, or instructions that may be employed to predict how different themes associated with an organization may influence one or more performance outcomes, including revenue or risks associated with the organization.

As used herein, the terms “large language model,” or “LLM” refer to data structures, programs, or the like, that may be trained or designed to perform a variety of natural language processing tasks. Typically, LLMs may generate responses in response to prompts. Often, LLMs may be considered to be neural networks that have been trained on large collections of natural language source documents. Accordingly, in some cases, LLMs may be trained to generate predictive responses based on provided prompts. LLM prompts may include context information, examples, or the like, that may enable LLMs to generate responses directed to specific queries or particular problems that go beyond conventional NLP.

As used herein, the terms “thematic signature” refers to one or more data structures that contain information associated with the themes or theme mentions that may be included in publications. In some cases, thematic signatures may be configured to be provided to LLMs.

As used herein the term “configuration information” refers to information that may include rule based policies, pattern matching, scripts (e.g., computer readable instructions), or the like, that may be provided from various sources, including, configuration files, databases, user input, built-in defaults, plug-ins, extensions, or the like, or combination thereof.

The following briefly describes embodiments of the invention in order to provide a basic understanding of some aspects of the invention. This brief description is not intended as an extensive overview. It is not intended to identify key or critical elements, or to delineate or otherwise narrow the scope. Its purpose is merely to present some concepts in a simplified form as a prelude to the more detailed description that is presented later.

Briefly stated, various embodiments are directed to managing data in a network for evaluating investment portfolios based on thematic concepts. In one or more of the various embodiments, natural language processing may be employed to determine one or more thematic mentions of concepts in one or more publications such that each publication may be associated with one or more publication weights associated with an importance or a veracity of each publication.

In one or more of the various embodiments, one or more thematic scores associated with the one or more organizations may be generated based on the one or more thematic mentions and the one or more publication weights.

In one or more of the various embodiments, one or more thematic models may be determined based on the one or more organizations and one or more performance outcomes such that each thematic model may predict a performance outcome based on the one or more thematic scores associated with the one or more organizations.

In one or more of the various embodiments, the one or more thematic models may be employed to predict the one or more predicted outcomes for the one or more organizations based on the one or more thematic scores such that the one or more predicted outcomes may be displayed in a report.

In one or more of the various embodiments, one or more additional publications associated with the one or more organizations may be employed to cause more actions, including: retraining the one or more thematic models based on one or more other thematic mentions of one or more other concepts included in the one or more additional publications; generating another report that includes one or more additional predicted outcomes based on the one or more retrained thematic models; or the like.

In one or more of the various embodiments, one or more thematic weights of the one or more thematic mentions within the one or more publications may be determined based on the natural language processing. In some embodiments, the one or more thematic weights may be employed to adjust the one or more thematic scores for each publication.

In one or more of the various embodiments, one or more data structures may be generated for one or more thematic signatures that may be configured to submit to one or more large language models based on the one or more thematic mentions. In some embodiments, one or more responses from the one or more large language models may be generated based on a submission of the one or more thematic signatures to a large language model. In some embodiments, one or more portions of the one or more thematic mentions may be classified as one or more of a consumer mention or a producer mention based on the one or more responses. In some embodiments, each portion of the one or more thematic mentions classified as consumer mentions may be excluded from the generation of the one or more thematic scores.

In one or more of the various embodiments, the one or more predicted outcomes may include one or more of a revenue value for the one or more organizations, or one or more risk values for the one or more organizations.

In one or more of the various embodiments, one or more other organizations may be associated into one or more portfolios. In some embodiments, a thematic composition of the one or more portfolios may be determined based on one or more other thematic mentions associated with the one or more other organizations. In some embodiments, one or more portfolio thematic scores for the one or more portfolios may be determined based on one or more other thematic scores associated with each of the one or more other organizations. In some embodiments, the one or more portfolio thematic scores may be compared to one or more profiles associated with the one or more portfolios such that the one or more profiles may declare at least an allocation of one or more themes for each portfolio. In some embodiments, one or more reports that identify one or more deficiencies in the one or more portfolios may be generated such that each deficiency may correspond to a misallocation of the one or more themes in the one or more portfolios.

In one or more of the various embodiments, one or more historical publications associated with the one or more organizations may be ingested. In some embodiments, historical performance information associated with the one or more organizations may be determined. In some embodiments, one or more historical thematic mentions in the one or more historical publications may be determined based on the natural language processing or one or more large language models.

In some embodiments, one or more candidate thematic models may be generated based on the historical performance information and the one or more historical thematic mentions. In some embodiments, the one or more candidate thematic models may be employed to predict one or more historical outcomes for the one or more organizations. In some embodiments, the one or more historical outcomes may be compared to the historical performance information such that each candidate thematic model that predicts a historical outcome that may be within an acceptable error range may be designated as a thematic model.

In one or more of the various embodiments, the one or more publications associated with the one or more organizations may be ingested. In some embodiments, one or more of a knowledge graph, an index, or an ontology that represents one or more themes may be generated based on the one or more publications. In some embodiments, the one or more thematic mentions may be determined based on the one or more of the knowledge graph, the index, or the ontology.

### Illustrated Operating Environment

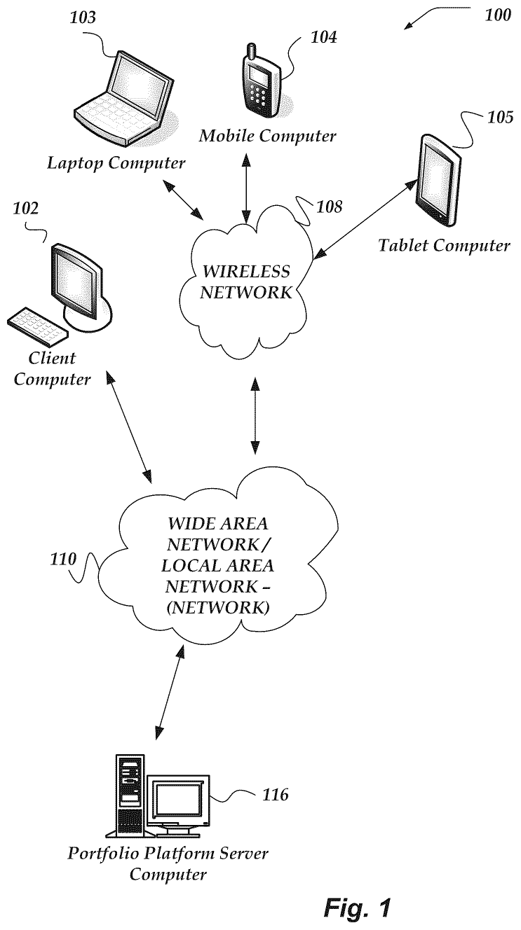

FIG. 1 shows components of one embodiment of an environment in which embodiments of the invention may be practiced. Not all of the components may be required to practice the invention, and variations in the arrangement and type of the components may be made without departing from the spirit or scope of the invention. As shown, system 100 of FIG. 1 includes local area networks (LANs)/wide area networks (WANs)-(network) 110, wireless network 108, client computers 102-105, portfolio platform server computer 116, or the like.

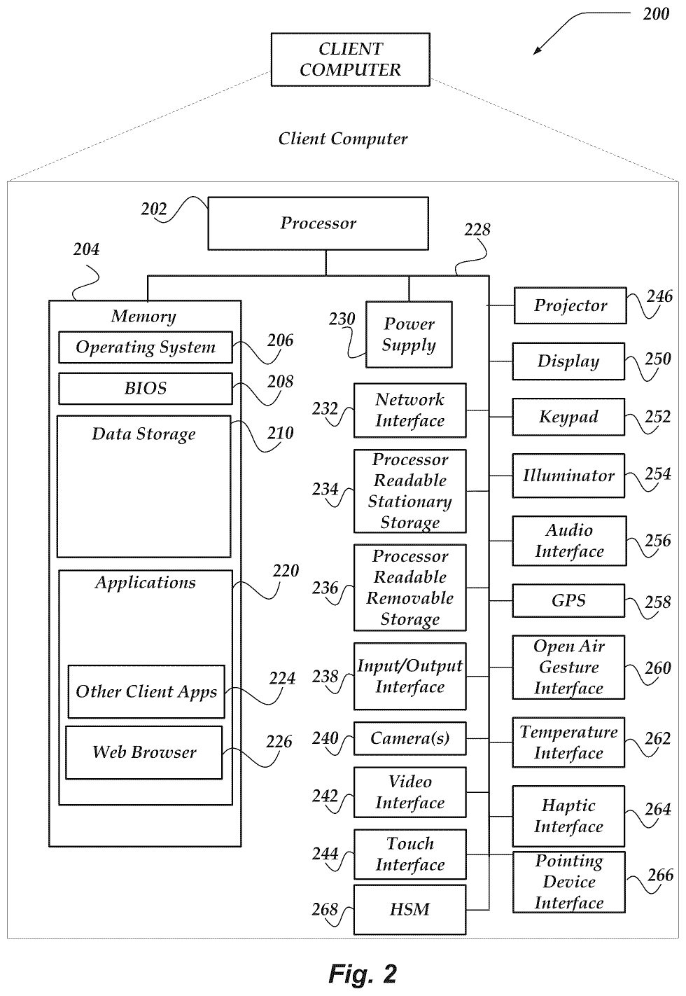

At least one embodiment of client computers 102-105 is described in more detail below in conjunction with FIG. 2. In one embodiment, at least some of client computers 102-105 may operate over one or more wired or wireless networks, such as networks 108, or 110. Generally, client computers 102-105 may include virtually any computer capable of communicating over a network to send and receive information, perform various online activities, offline actions, or the like. In one embodiment, one or more of client computers 102-105 may be configured to operate within a business or other entity to perform a variety of services for the business or other entity. For example, client computers 102-105 may be configured to operate as a web server, firewall, client application, media player, mobile telephone, game console, desktop computer, or the like. However, client computers 102-105 are not constrained to these services and may also be employed, for example, as for end-user computing in other embodiments. It should be recognized that more or less client computers (as shown in FIG. 1) may be included within a system such as described herein, and embodiments are therefore not constrained by the number or type of client computers employed.

Computers that may operate as client computer 102 may include computers that typically connect using a wired or wireless communications medium such as personal computers, multiprocessor systems, microprocessor-based or programmable electronic devices, network PCs, or the like. In some embodiments, client computers 102-105 may include virtually any portable computer capable of connecting to another computer and receiving information such as, laptop computer 103, mobile computer 104, tablet computers 105, or the like. However, portable computers are not so limited and may also include other portable computers such as cellular telephones, display pagers, radio frequency (RF) devices, infrared (IR) devices, Personal Digital Assistants (PDAs), handheld computers, wearable computers, integrated devices combining one or more of the preceding computers, or the like. As such, client computers 102-105 typically range widely in terms of capabilities and features. Moreover, client computers 102-105 may access various computing applications, including a browser, or other web-based application.

A web-enabled client computer may include a browser application that is configured to send requests and receive responses over the web. The browser application may be configured to receive and display graphics, text, multimedia, and the like, employing virtually any web-based language. In one embodiment, the browser application is enabled to employ JavaScript, HyperText Markup Language (HTML), extensible Markup Language (XML), JavaScript Object Notation (JSON), Cascading Style Sheets (CSS), or the like, or combination thereof, to display and send a message. In one embodiment, a user of the client computer may employ the browser application to perform various activities over a network (online). However, another application may also be used to perform various online activities.

Client computers 102-105 also may include at least one other client application that is configured to receive or send content between another computer. The client application may include a capability to send or receive content, or the like. The client application may further provide information that identifies itself, including a type, capability, name, and the like. In one embodiment, client computers 102-105 may uniquely identify themselves through any of a variety of mechanisms, including an Internet Protocol (IP) address, a phone number, Mobile Identification Number (MIN), an electronic serial number (ESN), a client certificate, or other device identifier. Such information may be provided in one or more network packets, or the like, sent between other client computers, ingestion platform server computer 116, profile correlation server computer 118, or other computers.

Client computers 102-105 may further be configured to include a client application that enables an end-user to log into an end-user account that may be managed by another computer, such as ingestion platform server computer 116, profile correlation server computer 118, or the like. Such an end-user account, in one non-limiting example, may be configured to enable the end-user to manage one or more online activities, including in one non-limiting example, project management, software development, system administration, configuration management, search activities, social networking activities, browse various websites, communicate with other users, or the like. Also, client computers may be arranged to enable users to display reports, interactive user-interfaces, or results provided by portfolio platform server computer 116, or the like.

Wireless network 108 is configured to couple client computers 103-105 and its components with network 110. Wireless network 108 may include any of a variety of wireless sub-networks that may further overlay stand-alone ad-hoc networks, and the like, to provide an infrastructure-oriented connection for client computers 103-105. Such sub-networks may include mesh networks, Wireless LAN (WLAN) networks, cellular networks, and the like. In one embodiment, the system may include more than one wireless network.

Wireless network 108 may further include an autonomous system of terminals, gateways, routers, and the like connected by wireless radio links, and the like. These connectors may be configured to move freely and randomly and organize themselves arbitrarily, such that the topology of wireless network 108 may change rapidly.

Wireless network 108 may further employ a plurality of access technologies including 2nd (2G), 3rd (3G), 4th (4G) 5th (5G) generation radio access for cellular systems, WLAN, Wireless Router (WR) mesh, and the like. Access technologies such as 2G, 3G, 4G, 5G, and future access networks may enable wide area coverage for mobile computers, such as client computers 103-105 with various degrees of mobility. In one non-limiting example, wireless network 108 may enable a radio connection through a radio network access such as Global System for Mobil communication (GSM), General Packet Radio Services (GPRS), Enhanced Data GSM Environment (EDGE), code division multiple access (CDMA), time division multiple access (TDMA), Wideband Code Division Multiple Access (WCDMA), High Speed Downlink Packet Access (HSDPA), Long Term Evolution (LTE), and the like. In essence, wireless network 108 may include virtually any wireless communication mechanism by which information may travel between client computers 103-105 and another computer, network, a cloud-based network, a cloud instance, or the like.

Network 110 is configured to couple network computers with other computers, including portfolio platform computer 116, client computers 102, and client computers 103-105 through wireless network 108, or the like. Network 110 is enabled to employ any form of computer readable media for communicating information from one electronic device to another. Also, network 110 can include the Internet in addition to local area networks (LANs), wide area networks (WANs), direct connections, such as through a universal serial bus (USB) port, Ethernet port, other forms of computer-readable media, or any combination thereof. On an interconnected set of LANs, including those based on differing architectures and protocols, a router acts as a link between LANs, enabling messages to be sent from one to another. In addition, communication links within LANs typically include twisted wire pair or coaxial cable, while communication links between networks may utilize analog telephone lines, full or fractional dedicated digital lines including T1, T2, T3, and T4, or other carrier mechanisms including, for example, E-carriers, Integrated Services Digital Networks (ISDNs), Digital Subscriber Lines (DSLs), wireless links including satellite links, or other communications links known to those skilled in the art. Moreover, communication links may further employ any of a variety of digital signaling technologies, including without limit, for example, DS-0, DS-1, DS-2, DS-3, DS-4, OC-3, OC-12, OC-48, or the like. Furthermore, remote computers and other related electronic devices could be remotely connected to either LANs or WANs via a modem and temporary telephone link. In one embodiment, network 110 may be configured to transport information of an Internet Protocol (IP).

Additionally, communication media typically embodies computer readable instructions, data structures, program modules, or other transport mechanism and includes any information non-transitory delivery media or transitory delivery media. By way of example, communication media includes wired media such as twisted pair, coaxial cable, fiber optics, wave guides, and other wired media and wireless media such as acoustic, RF, infrared, and other wireless media.

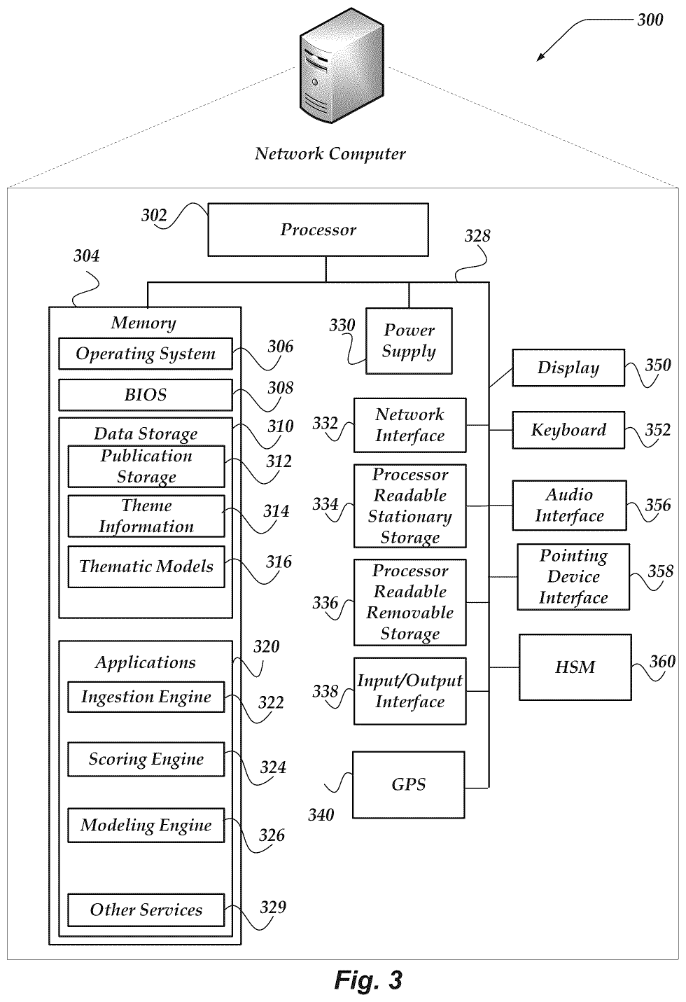

Also, one embodiment of portfolio platform server computer 116 is described in more detail below in conjunction with FIG. 3. Although FIG. 1 illustrates portfolio platform server computer 116, or the like, as a single computer, the innovations or embodiments are not so limited. For example, one or more functions of portfolio platform server computer 116, or the like, may be distributed across one or more distinct network computers. Moreover, in one or more embodiments, portfolio platform server computer 116 may be implemented using a plurality of network computers. Further, in one or more of the various embodiments, portfolio platform server computer 116, or the like, may be implemented using one or more cloud instances in one or more cloud networks. Accordingly, these innovations and embodiments are not to be construed as being limited to a single environment, and other configurations, and other architectures are also envisaged.

### Illustrative Client Computer

FIG. 2 shows one embodiment of client computer 200 that may include many more or less components than those shown. Client computer 200 may represent, for example, one or more embodiments of mobile computers or client computers shown in FIG. 1.

Client computer 200 may include processor 202 in communication with memory 204 via bus 228. Client computer 200 may also include power supply 230, network interface 232, audio interface 256, display 250, keypad 252, illuminator 254, video interface 242, input/output interface 238, haptic interface 264, global positioning systems (GPS) receiver 258, open air gesture interface 260, temperature interface 262, camera(s) 240, projector 246, pointing device interface 266, processor-readable stationary storage device 234, and processor-readable removable storage device 236. Client computer 200 may optionally communicate with a base station (not shown), or directly with another computer. And in one embodiment, although not shown, a gyroscope may be employed within client computer 200 to measuring or maintaining an orientation of client computer 200.

Power supply 230 may provide power to client computer 200. A rechargeable or non-rechargeable battery may be used to provide power. The power may also be provided by an external power source, such as an AC adapter or a powered docking cradle that supplements or recharges the battery.

Network interface 232 includes circuitry for coupling client computer 200 to one or more networks, and is constructed for use with one or more communication protocols and technologies including, but not limited to, protocols and technologies that implement any portion of the OSI model for mobile communication (GSM), CDMA, time division multiple access (TDMA), UDP, TCP/IP, SMS, MMS, GPRS, WAP, UWB, WiMax, SIP/RTP, GPRS, EDGE, WCDMA, LTE, UMTS, OFDM, CDMA2000, EV-DO, HSDPA, or any of a variety of other wireless communication protocols. Network interface 232 is sometimes known as a transceiver, transceiving device, or network interface card (NIC).

Audio interface 256 may be arranged to produce and receive audio signals such as the sound of a human voice. For example, audio interface 256 may be coupled to a speaker and microphone (not shown) to enable telecommunication with others or generate an audio acknowledgment for some action. A microphone in audio interface 256 can also be used for input to or control of client computer 200, e.g., using voice recognition, detecting touch based on sound, and the like.

Display 250 may be a liquid crystal display (LCD), gas plasma, electronic ink, light emitting diode (LED), Organic LED (OLED) or any other type of light reflective or light transmissive display that can be used with a computer. Display 250 may also include a touch interface 244 arranged to receive input from an object such as a stylus or a digit from a human hand, and may use resistive, capacitive, surface acoustic wave (SAW), infrared, radar, or other technologies to sense touch or gestures.

Projector 246 may be a remote handheld projector or an integrated projector that is capable of projecting an image on a remote wall or any other reflective object such as a remote screen.

Video interface 242 may be arranged to capture video images, such as a still photo, a video segment, an infrared video, or the like. For example, video interface 242 may be coupled to a digital video camera, a web-camera, or the like. Video interface 242 may comprise a lens, an image sensor, and other electronics. Image sensors may include a complementary metal-oxide-semiconductor (CMOS) integrated circuit, charge-coupled device (CCD), or any other integrated circuit for sensing light.

Keypad 252 may comprise any input device arranged to receive input from a user. For example, keypad 252 may include a push button numeric dial, or a keyboard. Keypad 252 may also include command buttons that are associated with selecting and sending images.

Illuminator 254 may provide a status indication or provide light. Illuminator 254 may remain active for specific periods of time or in response to event messages. For example, when illuminator 254 is active, it may back-light the buttons on keypad 252 and stay on while the client computer is powered. Also, illuminator 254 may back-light these buttons in various patterns when particular actions are performed, such as dialing another client computer. Illuminator 254 may also cause light sources positioned within a transparent or translucent case of the client computer to illuminate in response to actions.

Further, client computer 200 may also comprise hardware security module (HSM) 268 for providing additional tamper resistant safeguards for generating, storing or using security/cryptographic information such as, keys, digital certificates, passwords, passphrases, two-factor authentication information, or the like. In some embodiments, hardware security module may be employed to support one or more standard public key infrastructures (PKI), and may be employed to generate, manage, or store keys pairs, or the like. In some embodiments, HSM 268 may be a stand-alone computer, in other cases, HSM 268 may be arranged as a hardware card that may be added to a client computer.

Client computer 200 may also comprise input/output interface 238 for communicating with external peripheral devices or other computers such as other client computers and network computers. The peripheral devices may include an audio headset, virtual reality headsets, display screen glasses, remote speaker system, remote speaker and microphone system, and the like. Input/output interface 238 can utilize one or more technologies, such as Universal Serial Bus (USB), Infrared, WiFi, WiMax, Bluetooth™, and the like.

Input/output interface 238 may also include one or more sensors for determining geolocation information (e.g., GPS), monitoring electrical power conditions (e.g., voltage sensors, current sensors, frequency sensors, and so on), monitoring weather (e.g., thermostats, barometers, anemometers, humidity detectors, precipitation scales, or the like), or the like. Sensors may be one or more hardware sensors that collect or measure data that is external to client computer 200.

Haptic interface 264 may be arranged to provide tactile feedback to a user of the client computer. For example, the haptic interface 264 may be employed to vibrate client computer 200 in a particular way when another user of a computer is calling. Temperature interface 262 may be used to provide a temperature measurement input or a temperature changing output to a user of client computer 200. Open air gesture interface 260 may sense physical gestures of a user of client computer 200, for example, by using single or stereo video cameras, radar, a gyroscopic sensor inside a computer held or worn by the user, or the like. Camera 240 may be used to track physical eye movements of a user of client computer 200.

GPS transceiver 258 can determine the physical coordinates of client computer 200 on the surface of the Earth, which typically outputs a location as latitude and longitude values. GPS transceiver 258 can also employ other geo-positioning mechanisms, including, but not limited to, triangulation, assisted GPS (AGPS), Enhanced Observed Time Difference (E-OTD), Cell Identifier (CI), Service Area Identifier (SAI), Enhanced Timing Advance (ETA), Base Station Subsystem (BSS), or the like, to further determine the physical location of client computer 200 on the surface of the Earth. It is understood that under different conditions, GPS transceiver 258 can determine a physical location for client computer 200. In one or more embodiments, however, client computer 200 may, through other components, provide other information that may be employed to determine a physical location of the client computer, including for example, a Media Access Control (MAC) address, IP address, and the like.

In at least one of the various embodiments, applications, such as, operating system 206, other client apps 224, web browser 226, or the like, may be arranged to employ geo-location information to select one or more localization features, such as, time zones, languages, currencies, calendar formatting, or the like. Localization features may be used in user-interfaces, reports, as well as internal processes or databases. In at least one of the various embodiments, geo-location information used for selecting localization information may be provided by GPS 258. Also, in some embodiments, geolocation information may include information provided using one or more geolocation protocols over the networks, such as, wireless network 108 or network 111.

Human interface components can be peripheral devices that are physically separate from client computer 200, allowing for remote input or output to client computer 200. For example, information routed as described here through human interface components such as display 250 or keyboard 252 can instead be routed through network interface 232 to appropriate human interface components located remotely. Examples of human interface peripheral components that may be remote include, but are not limited to, audio devices, pointing devices, keypads, displays, cameras, projectors, and the like. These peripheral components may communicate over networks implemented using WiFi, Bluetooth™, Bluetooth LTE™, and the like. One non-limiting example of a client computer with such peripheral human interface components is a wearable computer, which might include a remote pico projector along with one or more cameras that remotely communicate with a separately located client computer to sense a user's gestures toward portions of an image projected by the pico projector onto a reflected surface such as a wall or the user's hand.

A client computer may include web browser application 226 that is configured to receive and to send web pages, web-based messages, graphics, text, multimedia, and the like. The client computer's browser application may employ virtually any programming language, including a wireless application protocol messages (WAP), and the like. In one or more embodiments, the browser application is enabled to employ Handheld Device Markup Language (HDML), Wireless Markup Language (WML), WMLScript, JavaScript, Standard Generalized Markup Language (SGML), HyperText Markup Language (HTML), extensible Markup Language (XML), HTML5, and the like.

Memory 204 may include RAM, ROM, or other types of memory. Memory 204 illustrates an example of computer-readable storage media (devices) for storage of information such as computer-readable instructions, data structures, program modules or other data. Memory 204 may store BIOS 208 for controlling low-level operation of client computer 200. The memory may also store operating system 206 for controlling the operation of client computer 200. It will be appreciated that this component may include a general-purpose operating system such as a version of UNIX, or Linux®, or a specialized client computer operating system such as iOS, or the like. The operating system may include, or interface with a Java virtual machine module that enables control of hardware components or operating system operations via Java application programs.

Memory 204 may further include one or more data storage 210, which can be utilized by client computer 200 to store, among other things, applications 220 or other data. For example, data storage 210 may also be employed to store information that describes various capabilities of client computer 200. The information may then be provided to another device or computer based on any of a variety of methods, including being sent as part of a header during a communication, sent upon request, or the like. Data storage 210 may also be employed to store social networking information including address books, buddy lists, aliases, user profile information, or the like. Data storage 210 may further include program code, data, algorithms, and the like, for use by a processor, such as processor 202 to execute and perform actions. In one embodiment, at least some of data storage 210 might also be stored on another component of client computer 200, including, but not limited to, non-transitory processor-readable removable storage device 236, processor-readable stationary storage device 234, or even external to the client computer.

Applications 220 may include computer executable instructions which, when executed by client computer 200, transmit, receive, or otherwise process instructions and data. Applications 220 may include, for example, other client applications 224, web browser 226, or the like. Client computers may be arranged to exchange communications one or more servers or other computers.

Other examples of application programs include calendars, search programs, email client applications, IM applications, SMS applications, Voice Over Internet Protocol (VOIP) applications, contact managers, task managers, transcoders, database programs, word processing programs, security applications, spreadsheet programs, games, search programs, visualization applications, and so forth.

Additionally, in one or more embodiments (not shown in the figures), client computer 200 may include an embedded logic hardware device instead of a CPU, such as, an Application Specific Integrated Circuit (ASIC), Field Programmable Gate Array (FPGA), Programmable Array Logic (PAL), or the like, or combination thereof. The embedded logic hardware device may directly execute its embedded logic to perform actions. Also, in one or more embodiments (not shown in the figures), client computer 200 may include one or more hardware micro-controllers instead of CPUs.

In one or more embodiments, the one or more micro-controllers may directly execute their own embedded logic to perform actions and access its own internal memory and its own external Input and Output Interfaces (e.g., hardware pins or wireless transceivers) to perform actions, such as System On a Chip (SOC), or the like.

### Illustrative Network Computer

FIG. 3 shows one embodiment of network computer 300 that may be included in a system implementing one or more of the various embodiments. Network computer 300 may include many more or less components than those shown in FIG. 3. However, the components shown are sufficient to disclose an illustrative embodiment for practicing these innovations. Network computer 300 may represent, for example, one or more embodiments of portfolio platform server computer 116, or the like, of FIG. 1.

Network computers, such as, network computer 300 may include a processor 302 that may be in communication with a memory 304 via a bus 328. In some embodiments, processor 302 may be comprised of one or more hardware processors, or one or more processor cores. In some cases, one or more of the one or more processors may be specialized processors designed to perform one or more specialized actions, such as, those described herein. Network computer 300 also includes a power supply 330, network interface 332, audio interface 356, display 350, keyboard 352, input/output interface 338, processor-readable stationary storage device 334, and processor-readable removable storage device 336. Power supply 330 provides power to network computer 300.

Network interface 332 includes circuitry for coupling network computer 300 to one or more networks, and is constructed for use with one or more communication protocols and technologies including, but not limited to, protocols and technologies that implement any portion of the Open Systems Interconnection model (OSI model), global system for mobile communication (GSM), code division multiple access (CDMA), time division multiple access (TDMA), user datagram protocol (UDP), transmission control protocol/Internet protocol (TCP/IP), Short Message Service (SMS), Multimedia Messaging Service (MMS), general packet radio service (GPRS), WAP, ultra-wide band (UWB), IEEE 802.16 Worldwide Interoperability for Microwave Access (WiMax), Session Initiation Protocol/Real-time Transport Protocol (SIP/RTP), or any of a variety of other wired and wireless communication protocols. Network interface 332 is sometimes known as a transceiver, transceiving device, or network interface card (NIC). Network computer 300 may optionally communicate with a base station (not shown), or directly with another computer.

Audio interface 356 is arranged to produce and receive audio signals such as the sound of a human voice. For example, audio interface 356 may be coupled to a speaker and microphone (not shown) to enable telecommunication with others or generate an audio acknowledgment for some action. A microphone in audio interface 356 can also be used for input to or control of network computer 300, for example, using voice recognition.

Display 350 may be a liquid crystal display (LCD), gas plasma, electronic ink, light emitting diode (LED), Organic LED (OLED) or any other type of light reflective or light transmissive display that can be used with a computer. In some embodiments, display 350 may be a handheld projector or pico projector capable of projecting an image on a wall or other object.

Network computer 300 may also comprise input/output interface 338 for communicating with external devices or computers not shown in FIG. 3. Input/output interface 338 can utilize one or more wired or wireless communication technologies, such as USB™, Firewire™, WiFi, WiMax, Thunderbolt™, Infrared, Bluetooth™, Zigbee™, serial port, parallel port, and the like.

Also, input/output interface 338 may also include one or more sensors for determining geolocation information (e.g., GPS), monitoring electrical power conditions (e.g., voltage sensors, current sensors, frequency sensors, and so on), monitoring weather (e.g., thermostats, barometers, anemometers, humidity detectors, precipitation scales, or the like), or the like. Sensors may be one or more hardware sensors that collect or measure data that is external to network computer 300. Human interface components can be physically separate from network computer 300, allowing for remote input or output to network computer 300. For example, information routed as described here through human interface components such as display 350 or keyboard 352 can instead be routed through the network interface 332 to appropriate human interface components located elsewhere on the network. Human interface components include any component that allows the computer to take input from, or send output to, a human user of a computer. Accordingly, pointing devices such as mice, styluses, track balls, or the like, may communicate through pointing device interface 358 to receive user input.

GPS transceiver 340 can determine the physical coordinates of network computer 300 on the surface of the Earth, which typically outputs a location as latitude and longitude values. GPS transceiver 340 can also employ other geo-positioning mechanisms, including, but not limited to, triangulation, assisted GPS (AGPS), Enhanced Observed Time Difference (E-OTD), Cell Identifier (CI), Service Area Identifier (SAI), Enhanced Timing Advance (ETA), Base Station Subsystem (BSS), or the like, to further determine the physical location of network computer 300 on the surface of the Earth. It is understood that under different conditions, GPS transceiver 340 can determine a physical location for network computer 300. In one or more embodiments, however, network computer 300 may, through other components, provide other information that may be employed to determine a physical location of the client computer, including for example, a Media Access Control (MAC) address, IP address, and the like.

In at least one of the various embodiments, applications, such as, operating system 306, ingestion engine 322, scoring engine 324, modeling engine 326, other services 329, or the like, may be arranged to employ geo-location information to select one or more localization features, such as, time zones, languages, currencies, currency formatting, calendar formatting, or the like. Localization features may be used in user interfaces, dashboards, reports, as well as internal processes or databases. In at least one of the various embodiments, geo-location information used for selecting localization information may be provided by GPS 340. Also, in some embodiments, geolocation information may include information provided using one or more geolocation protocols over the networks, such as, wireless network 108 or network 111.

Memory 304 may include Random Access Memory (RAM), Read-Only Memory (ROM), or other types of memory. Memory 304 illustrates an example of computer-readable storage media (devices) for storage of information such as computer-readable instructions, data structures, program modules or other data. Memory 304 stores a basic input/output system (BIOS) 308 for controlling low-level operation of network computer 300. The memory also stores an operating system 306 for controlling the operation of network computer 300. It will be appreciated that this component may include a general-purpose operating system such as a version of UNIX, or Linux® or a specialized operating system such as Microsoft Corporation's Windows operating system, or the Apple Corporation's macOS® operating system. The operating system may include, or interface with one or more virtual machine modules, such as, a Java virtual machine module that enables control of hardware components or operating system operations via Java application programs. Likewise, other runtime environments may be included.

Memory 304 may further include one or more data storage 310, which can be utilized by network computer 300 to store, among other things, applications 320 or other data. For example, data storage 310 may also be employed to store information that describes various capabilities of network computer 300. The information may then be provided to another device or computer based on any of a variety of methods, including being sent as part of a header during a communication, sent upon request, or the like. Data storage 310 may also be employed to store social networking information including address books, friend lists, aliases, user profile information, or the like. Data storage 310 may further include program code, data, algorithms, and the like, for use by a processor, such as processor 302 to execute and perform actions such as those actions described below. In one embodiment, at least some of data storage 310 might also be stored on another component of network computer 300, including, but not limited to, non-transitory media inside processor-readable removable storage device 336, processor-readable stationary storage device 334, or any other computer-readable storage device within network computer 300, or even external to network computer 300. Data storage 310 may include, for example, evidence data stores 312, knowledge graphs 314, ingestion models 316, portfolio models 318, scoring models 319, or the like.

Applications 320 may include computer executable instructions which, when executed by network computer 300, transmit, receive, or otherwise process messages (e.g., SMS, Multimedia Messaging Service (MMS), Instant Message (IM), email, or other messages), audio, video, and enable telecommunication with another user of another mobile computer. Other examples of application programs include calendars, search programs, email client applications, IM applications, SMS applications, Voice Over Internet Protocol (VOIP) applications, contact managers, task managers, transcoders, database programs, word processing programs, security applications, spreadsheet programs, games, search programs, and so forth. Applications 320 may include ingestion engine 322, scoring engine 324 modeling engine 326, other services 329, or the like, that may be arranged to perform actions for embodiments described below. In one or more of the various embodiments, one or more of the applications may be implemented as modules or components of another application. Further, in one or more of the various embodiments, applications may be implemented as operating system extensions, modules, plugins, or the like.

Furthermore, in one or more of the various embodiments, ingestion engine 322, scoring engine 324 modeling engine 326, other services 329, or the like, may be operative in a cloud-based computing environment. In one or more of the various embodiments, these applications, and others, that comprise the portfolio platform may be executing within virtual machines or virtual servers that may be managed in a cloud-based based computing environment. In one or more of the various embodiments, in this context the applications may flow from one physical network computer within the cloud-based environment to another depending on performance and scaling considerations automatically managed by the cloud computing environment. Likewise, in one or more of the various embodiments, virtual machines or virtual servers dedicated to ingestion engine 322, scoring engine 324 modeling engine 326, other services 329, or the like, may be provisioned and de-commissioned automatically.

Also, in one or more of the various embodiments, ingestion engine 322, scoring engine 324 modeling engine 326, other services 329, or the like, may be located in virtual servers running in a cloud-based computing environment rather than being tied to one or more specific physical network computers.

Further, network computer 300 may also comprise hardware security module (HSM) 360 for providing additional tamper resistant safeguards for generating, storing or using security/cryptographic information such as, keys, digital certificates, passwords, passphrases, two-factor authentication information, or the like. In some embodiments, hardware security module may be employed to support one or more standard public key infrastructures (PKI), and may be employed to generate, manage, or store keys pairs, or the like. In some embodiments, HSM 360 may be a stand-alone network computer, in other cases, HSM 360 may be arranged as a hardware card that may be installed in a network computer.

Additionally, in one or more embodiments (not shown in the figures), network computer 300 may include an embedded logic hardware device instead of a CPU, such as, an Application Specific Integrated Circuit (ASIC), Field Programmable Gate Array (FPGA), Programmable Array Logic (PAL), or the like, or combination thereof. The embedded logic hardware device may directly execute its embedded logic to perform actions. Also, in one or more embodiments (not shown in the figures), the network computer may include one or more hardware microcontrollers instead of a CPU. In one or more embodiments, the one or more microcontrollers may directly execute their own embedded logic to perform actions and access their own internal memory and their own external Input and Output Interfaces (e.g., hardware pins or wireless transceivers) to perform actions, such as System On a Chip (SOC), or the like.

### Illustrative Logical System Architecture

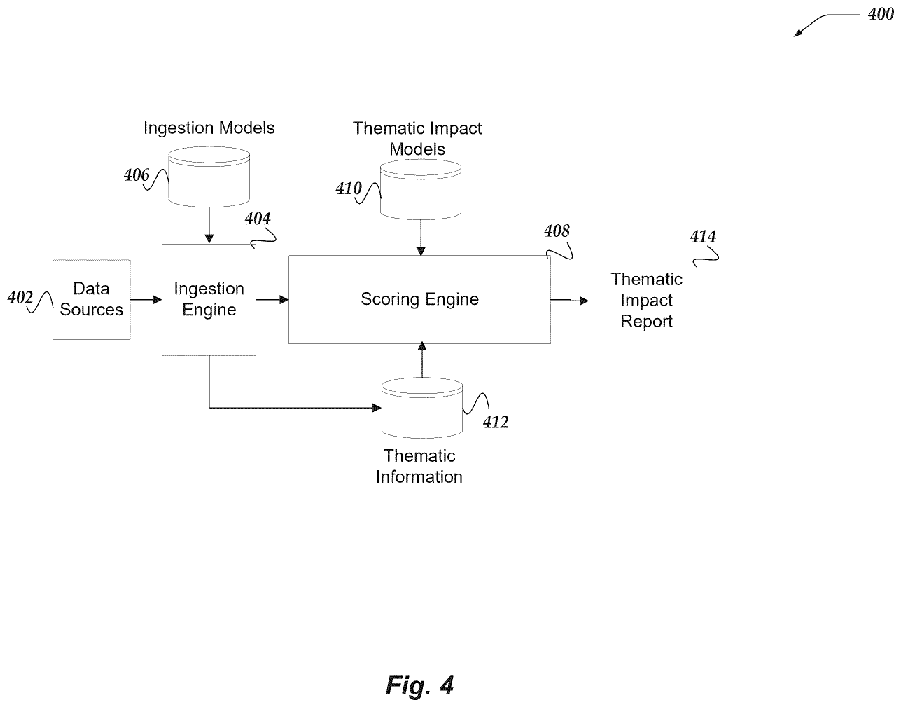

FIG. 4 illustrates a logical architecture of a portion of portfolio platform 400 for evaluating investment portfolios based on thematic concepts in accordance with one or more of the various embodiments. In one or more of the various embodiments, portfolio platforms, such as, portfolio platform 400 may include one or more sub-systems, including: one or more data sources, such as, data source 402; one or more ingestion engines, such as, ingestion engine 404; one or more ingestion models stored in one or more ingestion model data stores, such as, ingestion model data store 406; one or more scoring engines, such as scoring engine scoring engine 408; one or more thematic impact models, such as thematic impact model 410; thematic information data stores, such as, thematic information 412; or the like. Accordingly, in some embodiments, portfolio platform 400 may be arranged to generate one or more reports, such as thematic impact report 414.

In one or more of the various embodiments, portfolio platforms may be arranged to receive or obtain raw data from data source 402. In some embodiments, raw data may be information provided from one or more private or public sources. In some embodiments, data sources may include news articles, press releases, social media information, government filings/records, court filings, litigation summaries, curated data sets, conference reports, or the like. In some embodiments, raw information may generally be text based. However, in some embodiments, one or more actions for extracting, transforming, or loading (ETL processing) may be performed by other services to clean up or format the raw information into text that may be suitable for additional automated analysis. For example, in some embodiments, audio files may be transcribed (automatically or otherwise) to text before providing to a portfolio platform. Also, in some embodiments, portfolio platforms may be arranged to include one or more additional (not shown) sub-systems that perform ETL actions.

In one or more of the various embodiments, data sources may include real-time streams of information, such as, news feeds, or the like, as well as periodic bulk transfers of information, such as, annual reports, monthly periodicals, or the like.

In one or more of the various embodiments, ingestion engines, such as, ingestion engine 404 may be arranged to process information from data sources, such as, data source 402. In some embodiments, ingestion engines may be arranged to employ one or more ingestion models, such as, ingestion model 406, to perform various analysis, categorization, or classification on the incoming information.

In one or more of the various embodiments, ingestion models may be one or more data structures that encapsulate the data, rules, machine learning models, machine learning classifiers, natural language processing instructions, or instructions that may be employed to match or map information provided by data sources to one or more knowledge graphs. Ingestion models may include various components, such as, one or more machine learning based classifiers, heuristics, rules, pattern matching, conditions, or the like, that may be employed to match or map information to one or more knowledge graphs. Different ingestion models may be provided for different categories of information. For example, one ingestion model may be directed to ingesting information included in press releases while another ingestion model may be directed to ingesting information included in formal public disclosures, such as, earning calls, merger notices, or the like.

In some embodiments, ingestion engines may be arranged to thematic information, such as thematic information 412 that may include catalogs of observed themes, prevalence information regarding themes or associated organizations, or the like. In some embodiments, thematic information may be considered to be one or more data stores that may store various thematic metrics including, metrics associated with particular data sources (e.g., quality/veracity scores), metrics associated with thematic impact within markets/subject matter segments, or the like. Further, in some embodiments, thematic information may be assumed to include one or more of knowledge graphs, indexes, or the like, that represent associations or relationships between different concepts. In some embodiments, ingestion engines may be arranged to generate thematic information while ingesting publications. Note, for brevity and clarity, a detailed discussion of NLP, machine learning processes, or the like, employed to determine or evaluate themes included in publications is omitted here. However, one of ordinary skill in the art will appreciate the there are various methods and algorithms for identifying themes or theme prominence within a publication. Also, in some embodiments, scoring engines may be arranged to employ one or more external services that may offer APIs to perform some thematic analysis of publications.

Also, in some embodiments, given that theme analysis may be considered a dynamic field, portfolio platforms or scoring engines may be arranged to be adaptive to new techniques. Accordingly, in some embodiments, portfolio platforms may be arranged to employ libraries, rules, instructions, APIs, or the like, provided via configuration information to account for local requirements or local circumstances. For example, in some embodiments, if a new sentiment analysis method may be discovered, portfolio platform users may be enabled to configure scoring engines to employ those methods via configuration information.

In one or more of the various embodiments, scoring engines, such as, scoring engine 408 may be arranged to employ one or more thematic impact models, such as thematic impact models 410 to predict how various themes may impact one or more performance outcomes of organizations associated with the various themes.

In one or more of the various embodiments, thematic impact models, such as thematic impact models 410 may include the rules, instructions, formulas, weights, or the like, to compute thematic impact scores based on the thematic information associated with an organization. In some embodiments, different concepts or different themes may require one or more different rules, instructions, formulas, weights, or the like, to generate meaningful thematic scores. Accordingly, in some embodiments, thematic impact models may be provided by configuration information to enable new or different thematic impact models to be added to portfolio platforms. Likewise, in some embodiments, existing thematic impact models may be modified manually or automatically based on active or passive user feedback.

In some embodiments, scoring engines may be arranged to generate thematic impact reports, such as, thematic impact report 414. In some embodiments, such reports may include interaction reports (e.g., dashboards, graphical visualizations, or the like), static (hardcopy/printable) reports, information formatted for ingestion by other analysis or reporting systems, or the like. Accordingly, in some embodiments, scoring engines may be arranged to employ rules, filters, templates, report libraries, or the like, provided via configuration information to enable thematic reports that may be suitable for local requirements or local circumstances.

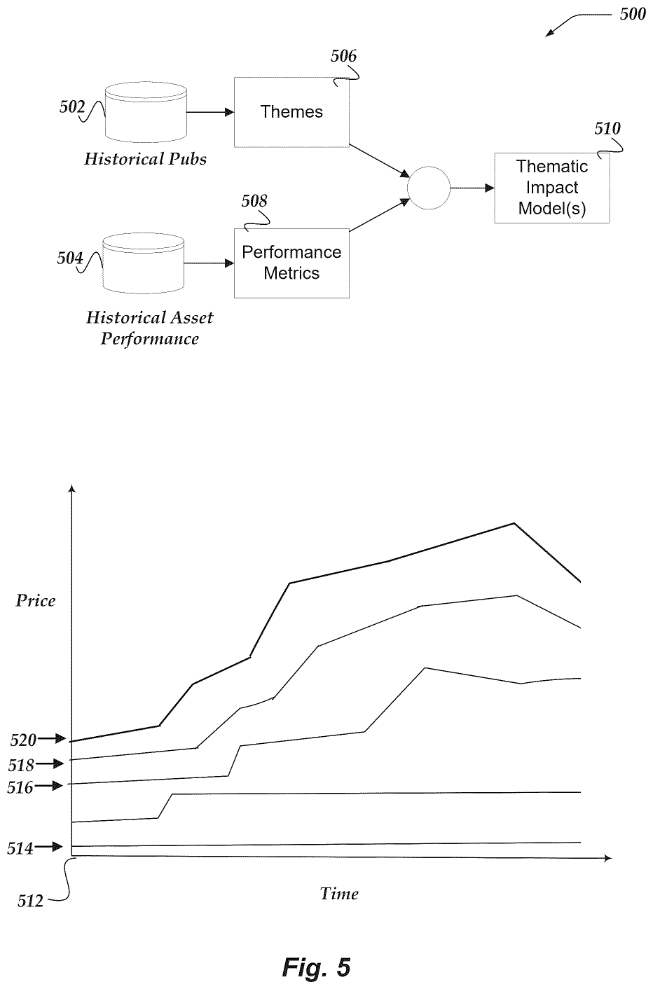

FIG. 5 illustrates a logical schematic of system 500 for evaluating investment portfolios based on thematic concepts in accordance with one or more of the various embodiments.

In some embodiments, scoring engines may be arranged to generate thematic impact models based on an analysis of the thematic content of historical publications and historical financial performance of organizations or markets.

As described above, in some embodiments, ingestion systems may be arranged to process historical publications associated with or about one or more organizations or markets. These publications may be provided by various sources. In some cases, information sources may include government reports, organization filings to government agencies, general news media providers, technical/specialized news media, technical or scientific journals, press releases, advertisement/marketing media, or the like. In some embodiments, ingestion systems may be arranged to identify themes or concepts that may be included in the publications.

In some embodiments, modeling engines may be arranged to generate one or more thematic impact models that predict how associations with one or more themes may impact the financial performance (or risk) outcomes for a given organization or group of organizations, such as portfolios, market segments, or the like.

Accordingly, in some embodiments, scoring engines (or ingestion engines) may be arranged to analyze incoming publications to determine the importance or prevalence of themes within a given publication. In some embodiments, scoring engines or ingestion engines may be arranged to execute various NLP processes to identify themes or determine their prominence within a given article or report. Note, ingestion engines may conduct some or all of the analysis to determine metrics associated with the importance or prevalence of themes in publications. Likewise, in some cases, some analysis for some metrics may be conducted by the scoring engine. Accordingly, in some embodiments, for brevity and clarity this distinction may be omitted in the disclosures herein. Thus, unless expressly excluded, one of ordinary skill in the art may assume that the scoring engines may perform some or all of the actions described for ingestion engines. For example, in some cases, scoring engines may be arranged to include ingestion engine features. Also, for example, in some cases, for some embodiments, ingestion engines may perform some or all ingestion activity or publication analysis while scoring engines may rely on metrics, indexes, knowledge graphs, theme ontologies, or the like, generated by ingestion engines.

In some embodiments, scoring engines may be arranged to assume that some or all revenue or risks associated with an organization may be associated with themes associated with the organization. For example, a large e-commerce sales or distribution platform may be associated with various themes such as, retail sales, consumer electronics, delivery services, or the like, with each theme contributing to a portion of the revenue or risks of the organization.

Accordingly, in some embodiments, scoring engines may be arranged to consume historical publications, such as historical publications 502 to determine how themes, such as themes 506 that may be associated with one or more organizations. Also, in some embodiments, scoring engines may be arranged to consume historical asset performance data, such as historical asset data 504. Accordingly, in some embodiments, scoring engines may be arranged to synthesize thematic models from themes 506 or performance metrics 508. Accordingly, in some embodiments, scoring engines may be arranged to employ thematic models 510 to predict how performance outcomes may be impacted by themes. Further, in some embodiments, scoring engines may be arranged to classify organizations as one or more or consumers, producers, retail providers, or the like, with respect to a given theme. Also, in some embodiments, scoring engines may be arranged to categorize organizations based on one or more of geographical location(s), market size, employee count, or the like. Accordingly, in some embodiments, scoring engines may be arranged to evaluate how theme mentions may correlate with performance outcomes for different classifications or categories of organizations. For example, some themes may have more impact for organizations that may be located in geographic areas than for otherwise similar organizations that may be located in different geographic areas. Accordingly, in some embodiments, scoring engines may be arranged to include weights, or the like, that may be associated with a classification or categorization of the organizations.

For example, for some embodiments, a graph such as graph 512 may be considered a plot of asset prices for an organization. Accordingly, in some embodiments, plot 520 may represent the current price of an asset while plots 512-518 may represent plots of price contributions of various themes that thematic impact models may predict. For example, plot 514 corresponds to first theme while plots 516 corresponds to another theme, and so on.

In one or more of the various embodiments, modeling engines may be arranged to iteratively evaluate the predictive performance of candidate thematic impact models. Accordingly, in some embodiments, if a thematic impact model does not provide accurate predictions, modeling engines may be arranged to iterate components of thematic impact models (e.g., weights, coefficients, or the like) and re-evaluate the thematic impact models until the thematic impact models meet a quality of prediction requirement.

Further, in some embodiments, modeling engines may be arranged to compare predictive performance of thematic models across different industries such that thematic models directed to particular industries may include different components or component values. Also, in some embodiments, modeling engines may be arranged to continuously or periodically employ multiple thematic models at the same time to compare the predictive performance of the compared thematic models.

Accordingly, in some embodiments, modeling engines may be arranged to adapt to the discovery of new modeling methods. Accordingly, in some embodiments, modeling engines may be arranged to determine the particular models used for evaluating investment portfolios based on thematic concepts based on rules, instructions, libraries, or the like, provided via configuration information to account for local requirements or local circumstances.

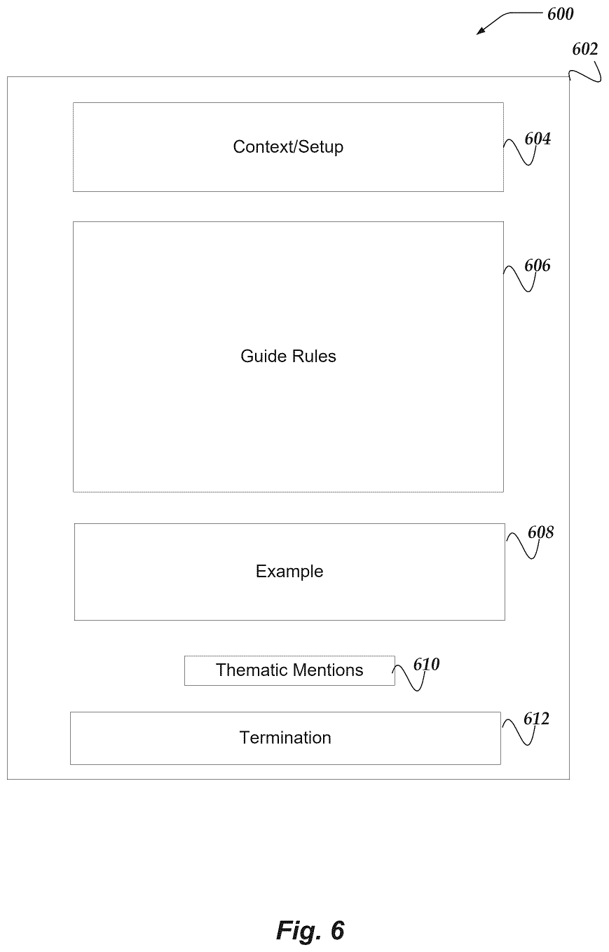

FIG. 6 illustrates a logical schematic of thematic signature data structure 600 for evaluating investment portfolios based on thematic concepts in accordance with one or more of the various embodiments. As described above, in some embodiments, scoring engines or modeling engines may be arranged to determine a thematic signature template from among one or more thematic signature templates. In some embodiments, if a thematic signature template may be determined and one or more thematic mentions (or associated publications) is provided, scoring engines or modeling engines may be arranged to generate a thematic signature data structure based on the thematic signature template and the thematic mentions.

One of ordinary skill in the art will appreciate that the particular contents or text included in thematic signature templates may vary depending on various factors, including, the large language model (e.g., different types/version/brands may require different thematic signature templates), format or content required for evaluating thematic mentions, or the like. In general thematic signature templates may be developed experimentally such that thematic signature templates that produce thematic signature data structures that may train large language models to evaluate thematic mentions to determine if the mention may be associated with consuming (or using) the items in a publication that may be associated with the themes or if the mention may be associated with producing (or offering) the items or services in the publication that may be associated with the themes. In some embodiments, thematic signature templates may be included in a thematic signature template repository or other large language model data store. In some cases, employing thematic signature data structures to train a more generalized language model to provide particular result that the language model may not explicitly be trained or tuned for may be referred to as zero-shot learning, few-shot learning, and so on, because the generalized language model (referred to herein as large language models) is trained by the thematic signature data structure. Accordingly, in some embodiments, large language models that consume thematic signature data structures may perform transfer learning, or the like, to provide specific results, such as, evaluating if an organization may be a theme consumer or theme producer. Thus, thematic signature data structures may be submitted to train or re-train otherwise static large language models to produce responses for evaluating thematic mentions. Accordingly, one of ordinary skill in the art will appreciate the thematic signature data structure may be separate or distinct from various meta-data that may be used for tuning large language models.

Accordingly, in some embodiments, the particular contents of thematic signature templates or thematic signature data structures may depend on the capabilities of the underlying large language model. Thus, in some cases, different large language models may require different thematic signature templates. Further, in some embodiments, different large language models may be engineered with different target audiences, problem domains, or the like. Accordingly, in some embodiments, scoring engines or modeling engines may be arranged to select among multiple large language models depending on the type of publications, type of organizations, type of themes, or the like.

In some embodiments, thematic signature templates may comprise a dataset container, such as, container 602 that may hold the contents for the thematic signature. Also, in some embodiments, thematic signature templates may be configured to include various sections, including, for example, context section 604, guide rule section 606, example section 608, thematic mentions placeholder 610, termination section 612, or the like. In some cases, for some embodiments, thematic signature templates may omit one or more sections. Likewise, in some embodiments, thematic signature templates may include one or more other sections. Further, in some cases, thematic signature templates may arrange the various sections in a different order than shown here. Thus, in some embodiments, scoring engines or modeling engines may be arranged to employ different thematic signature templates for different problems or different large language models as needed.

In one or more of the various embodiments, dataset containers may be variables, parameters, objects, data structures, or the like, that enable the thematic signature data structures to be passed to a large language model. In some cases, for some embodiments, a dataset container may be a buffer of text characters that form a string collection that may be included in the thematic signature data structure. Likewise, for example, a dataset container may be an object or class instance designed for handling the types of content included in a particular thematic signature data structure.

In one or more of the various embodiments, context sections such as context section 604 may be portions of a thematic signature template that inject statements that establish a working context that may aid in the training of the large language model to evaluate thematic mentions or publications. For example, in some embodiments, context sections may be employed to declare one or more features or characteristics of a theme consumer or theme producer. Accordingly, in some embodiments, large language models may incorporate this context information as part of the generative process that is trained to produce the responses that include evaluations of thematic mentions.

In one or more of the various embodiments, guide rule sections such as guide rule section 606 may be portions of a thematic signature template that inject one or more statements that may be selected to provide additional guidance or direction for training the large language model to generate responses for evaluating thematic mentions. For example, in some embodiments, guide rules may include statements that declare rules for omitting certain types of punctuation, omitting in-depth explanation text from response, directives to specifically or particularly take actions if certain words or text forms are encountered while generating responses, or the like.

In one or more of the various embodiments, example sections such as example section 608 may be portion of a thematic signature template that include one or more example thematic mentions and one or more example thematic mentions that may be consumer mentions or producer mentions. In some embodiments, if needed, the example information may guide the training of the large language model to generate a response that reports evaluations in formats that conforms the requirements of scoring engines or modeling engines.

In one or more of the various embodiments, thematic mentions placeholders such as thematic mention placeholder 610 may be specialized tokens, markers, mark-up, or the like, that indicate where in a thematic signature template the actual thematic mentions being evaluated should be embedded in the thematic signature. In some embodiments, one or more thematic mentions may be included in the same thematic signature data structure. Also, in some embodiments, entire publications may be included in thematic mentions sections.

In one or more of the various embodiments, termination sections such as termination section 612 may be portion of a thematic signature template that includes additional context information or guide rules that may be required to “close” the thematic signature data structure. For example, for some embodiments, termination sections may include a statement indicating the large language model should end the session, or the like.

Accordingly, in some embodiments, scoring engines may be arranged to employ thematic signatures with LLMs to classify organizations as one or more or consumers, producers, retail providers, or the like. Also, in some embodiments, scoring engines may be arranged to employ thematic signatures with LLMs to categorize organizations based on one or more of geographical location(s), market size, employee count, or the like.

### Generalized Operations

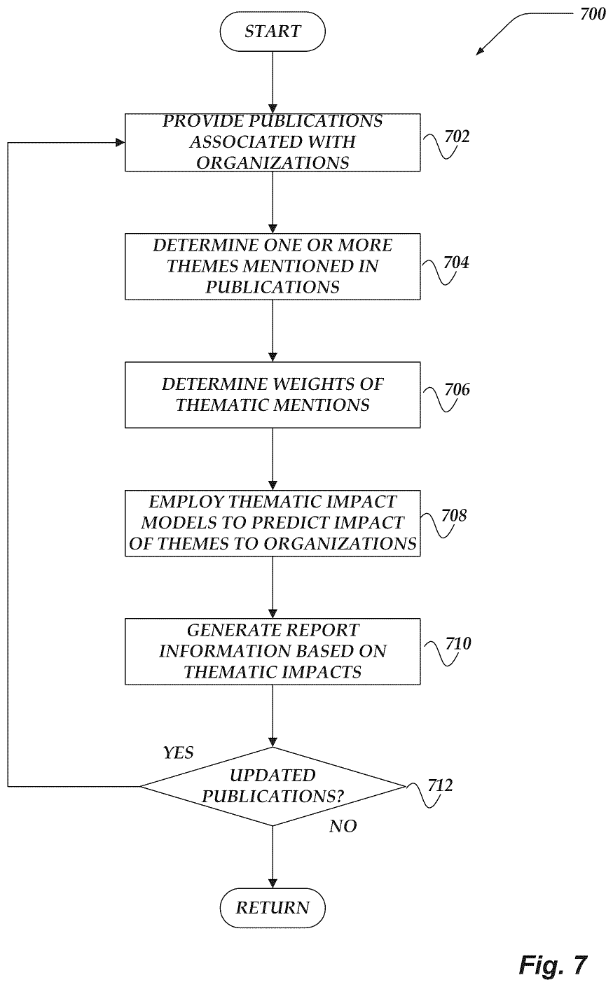

FIGS. 7-11 represent generalized operations for evaluating investment portfolios based on thematic concepts in accordance with one or more of the various embodiments. In one or more of the various embodiments, processes 700, 800, 900, 1000, and 1100 described in conjunction with FIGS. 7-11 may be implemented by or executed by one or more processors on a single network computer, such as network computer 300 of FIG. 3. In other embodiments, these processes, or portions thereof, may be implemented by or executed on a plurality of network computers, such as network computer 300 of FIG. 3. In yet other embodiments, these processes, or portions thereof, may be implemented by or executed on one or more virtualized computers, such as those in a cloud-based environment. However, embodiments are not so limited and various combinations of network computers, client computers, or the like may be utilized. Further, in one or more of the various embodiments, the processes described in conjunction with FIGS. 7-11 may perform actions for evaluating investment portfolios based on thematic concepts in accordance with at least one of the various embodiments or architectures such as those described in conjunction with FIGS. 1-6. Further, in one or more of the various embodiments, some or all of the actions performed by processes 700, 800, 900, 1000, and 1100 may be executed in part by ingestion engine 322, scoring engine 324 modeling engine 326, or the like.

FIG. 7 illustrates an overview flowchart for process 700 for evaluating investment portfolios based on thematic concepts in accordance with one or more of the various embodiments. After a start block, at block 702, in some embodiments, one or more publications that may be associated with one or more organizations may be provided. As described above, portfolio platforms may include one or more ingestion engines that may be arranged to collect documents, reports, press releases, public filings, or the like, that may be referred to collectively as publications. In some embodiments, ingestion engines may be arranged to continuously process incoming publications to generate or maintain thematic information for evaluating investment portfolios based on thematic concepts. In some embodiments, one or more publications may be provided directly from third-party publishers via one or more APIs. Also, in some embodiments, ingestion engines may be arranged to scan government agency document repositories, government agency announcements, or the like, for publications that include content that may be associated with one or more organizations, business areas, market segments, financial indexes, or the like.

At block 704, in one or more of the various embodiments, scoring engines may be arranged to determine one or more themes that may be mentioned in the one or more publications. In some embodiments, ingestion engines may generate one or more indexes, maps, dictionaries, knowledge graphs, or the like, that may indicate if themes may be mentioned in the ingested publications. Also, in some embodiments, scoring engines may be arranged to scan publication content to identify themes that may be mentioned in the publication content. In some embodiments, scoring engines may be arranged to refer to one or more indexes, knowledge graphs, ontologies, or the like, for identifying thematic mentions. For example, in some cases, one or more words or phrases in publication content may be associated with particular themes. Accordingly, in some embodiments, if words or phrases included in publication content may be associated with a particular theme, those words or phrases may be considered a mention of the associated theme. Also, in some cases, for some embodiments, one or more words or themes may be associated with more than one theme. Also, in some cases, for some embodiments, one or more themes may overlap or include other themes (sub-themes). For example, if a publication associated with an organization includes words or phrases such as, online shopping, Cyber Monday, secure checkout, or the like, the scoring engine may interpret them as mentions of the theme e-commerce. Also, in this same example, the words or phrases, such as, secure checkout may be considered a mention of the theme computer security or computer privacy.

At block 706, in one or more of the various embodiments, scoring engines may be arranged to determine one or more weight values for the one or more themes mentioned in the one or more publications. In some embodiments, different sources may be associated with different veracity, authenticity, or reliability. In some cases, ingestion engines or other sources of the publications may associate a score with a particular publication. Also, in some embodiments, scoring engines may provide user interfaces that enable users or administrators to assign an impact weight to a publication. Furter, in some embodiments, metrics collected from surveys or report user interfaces may enable users to rate the quality of an evaluation of investment portfolios based on thematic concepts. Accordingly, in some embodiments, such user ratings may be employed to automatically modify publication weights or otherwise supplement weights provided from the ingestion engines.

At block 708, in one or more of the various embodiments, scoring engines may be arranged to employ one or more thematic impact models to predict the impact of the thematic composition to the organizations. In some embodiments, scoring engines may be arranged to generate one or more thematic impact models based on historical information associated with organizations, groups of organizations market indexes, or the like, may be used to generate thematic impact models. Accordingly, in some embodiments, one or more thematic impact models may be directed to particular organizations, groups of organizations, market segments, or the like. Thus, in some embodiments, scoring engines may be arranged to automatically select one or more thematic impact models based on the organizations or portfolios being selected for evaluation. Likewise, in some embodiments, the selection of the particular thematic impact models may be influenced by one or more user preferences. For example, if a user (or client of a user) is more risk averse than other, conservative thematic impact models may be selected over aggressive thematic impact models.

At block 710, in one or more of the various embodiments, scoring engines may be arranged to generate report information based on the thematic impacts. In some embodiments, thematic impact models may be arranged to predict asset performance, such as stock prices, indexes values, or the like. In some embodiments, scoring engines may be arranged to predict the impact to performance contributed by one or more themes associated with an organization, group of organization, market indexes that may be under evaluation.

At decision block 712, in one or more of the various embodiments, if there may be updated publication available, control may loop back to block 702; otherwise, control may flow to a calling process.

In some embodiments, portfolio platforms may generally be assumed to continuously or periodically monitor publication sources for updated publications. Accordingly, in some embodiments, if updated publications may be available, they may be ingested or otherwise incorporated into training or retraining thematic impact models.

Also, in some embodiments, portfolio platforms may be arranged to monitor various publication sources or other data sources to determine if there may be new publications that may be ingested or otherwise incorporated into thematic impact models.

However, in some embodiments, portfolio platforms may include one user interfaces or configuration information that enables users or administrator to terminate the operations of a portfolio platform such that control may be returned to a calling process.

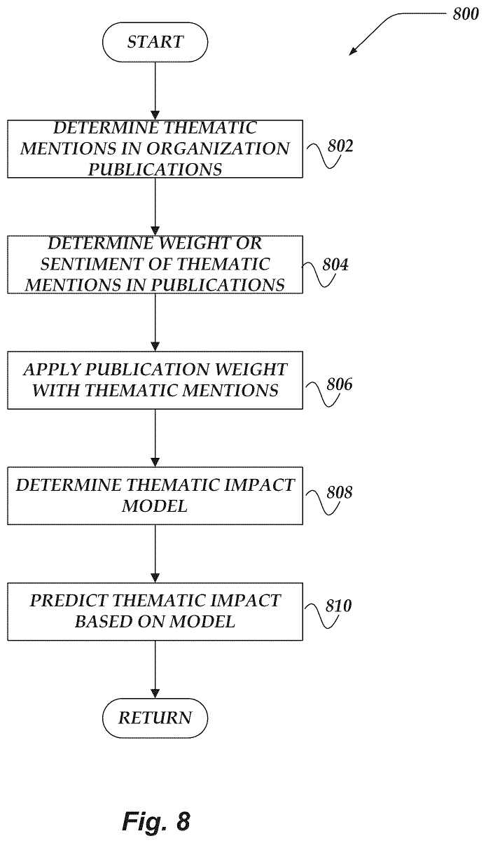

FIG. 8 illustrates a flowchart for process 800 for evaluating investment portfolios based on thematic concepts in accordance with one or more of the various embodiments. After a start block, at block 802, in some embodiments, scoring engines may be arranged to determine one or more themes mentioned in one or more publications. As described above, in some embodiments, publications associated with an organization may be evaluated to determine which themes may be mentioned in the publications. In some embodiments, themes associated with a publication may be included in an index or other intermediate data structure. Accordingly, in some embodiments, scoring engines may be arranged to refer to those indexes to determine metrics associated with thematic mentions rather than directly scanning the publication contents. Likewise, in some embodiments, scoring engines may be arranged to maintain an association between organizations and the particular publications that include the mentions of interest. Accordingly, in some embodiments, scoring engines may be arranged to retrieve publication contents to execute one or more analysis actions that may be employed to supplement information provided or determined during ingestion.

At block 804, in one or more of the various embodiments, scoring engines may be arranged to determine the weight or sentiment of one or more thematic mentions in the one or more publications. In some embodiments, scoring engines may be arranged to employ one or more weighting models to generate weight scores for themes. In some embodiments, thematic weight scores may be employed to represent the how much a given publication may emphasize the importance or prevalence of one or more particular themes. some embodiments, scoring engines may be arranged to employ one or more NLP models to generate weight score based on various NLP metrics, such as Term Frequency-Inversion Document Frequency (TF-IDF), word embeddings, named entity recognition, or the like. Note, one of ordinary skill in the art will appreciate that the particular operations used for importance or prevalence analysis may change as new or different techniques may be discovered or refined.

Also, in some embodiments, one or more techniques for determining importance or prevalence of themes in publication may require more time or resources than others. For example, a higher quality technique may require more compute resources or access to more expensive services or data sources. Thus, in some embodiments, scoring engines may be arranged to enable different type of prevalence or importance analysis depending on user preferences.

Accordingly, in some embodiments, scoring engines may be arranged to determine the particular actions for determining importance or prevalence of themes in publication based on rules, instructions, libraries, or the like, provided or determined based on configuration information to account for local requirements or local circumstances.

Also, in some embodiments, scoring engines (or ingestion engines) may be arranged to evaluate the sentiment associated with the themes mentioned in the publications. For example, in some embodiments, themes mentioned in a publication may be associated with positive or negative connotations. Accordingly, in some embodiments, scoring engines may be arranged to apply one or more sentiment analysis to theme mentions in publication to determine if the theme mention may be associated positive or negative sentiment.

Also, in some embodiments, related to sentiment, scoring engines may be arranged to classify or categorize the organizations associated with a theme mention. In some cases, such classifications may include consumer, producer, retail, or the like. Also, in some embodiments, organizations may be classified or categorized based on geographical location(s), market size, employee count, or the like. For example, a theme mention associated with cloud data storage will have a different impact if the organization is mentioned as using cloud data storage as compared to an organization that is mentioned as providing or developing cloud data storage services. In some embodiments, scoring engines (or ingestion engines) may be arranged to submit thematic signatures that include information associated with theme mentions to a generative artificial intelligence or large language model to evaluate if the theme mentions infer one or more classifications or categories for the organization that may be associated with the theme.

At block 806, in one or more of the various embodiments, scoring engines may be arranged to determine impact weights associated with the publications that include one or more thematic mentions. In one or more of the various embodiments, publications may be categorized based on various characteristics, including source/publisher, type of publication (e.g., government report, financial report, technical journal, popular science, public relation announcements, or the like), or the like. Accordingly, in some embodiments, scoring engines may be arranged to provide one or more user interfaces that enable administrators or other users to assign weights to publishers, publication types, or individual publications. Also, in some embodiments, modeling engines may be arranged to assign relative weights to publications or publication types as part of the process for generating thematic impact models. For example, in some embodiments, modeling engines may be arranged to use historical publications and historical financial information to generate thematic impact models. Accordingly, in some embodiments, modeling engines may be arranged to automatically determine which publications or publication types may correlate better with historical outcomes. For example, a publication may be determined to have a high prevalence for particular themes. However, in some embodiments, if the thematic mentions in such a publication have low correlation to actual outcomes, the publication may be down weighted or assigned a lower weight score than other publication that may be observed to have higher correlation with actual outcomes. Accordingly, in some embodiments, modeling engines may be arranged to objectively assign weights to publications or publication types. Note, modeling engines may be arranged to provide user interfaces that enable users or administrators to augment or override one or more of the publication weights determined by the modeling engine.

At block 808, in one or more of the various embodiments, scoring engines may be arranged to determine one or more thematic impact models based on the organizations or the mentioned themes. As mentioned above, in some embodiments, modeling engines may be arranged to generate more than one thematic impact model. In some embodiments, modeling engines may generate thematic impact models for individual organizations, groups of organizing, market segments, or the like. Accordingly, in some embodiments, scoring engines may be arranged to select one or more thematic impact models based on the organization(s) being evaluated.

Also, in some embodiments, modeling engines may be arranged to generate different times for different types of analysis or predictions. In some embodiments, some thematic impact models may be generated to predict different types of performance outcomes, such as stock price, real estate value, commodity prices, or the like, each with different thematic impact models. Likewise, in some embodiments, modeling engines may be arranged to generate different thematic impact models that may be directed to predicting outcomes for different time windows or time horizons. For example, in some embodiments, modeling engines may be arranged to generate different thematic impact models that are configured to predict outcomes that may occur in 30 days, 90 days, 1 year, 5 years, or the like. Thus, in some embodiments, thematic impact models may be selected based on their time window or time horizon.

At block 810, in one or more of the various embodiments, scoring engines may be arranged to predict one or more impacts to the organization based on the one or more thematic impact models. In some embodiments, scoring engines may be arranged to provide information about the thematic mentions, thematic weights, and publication weights to one or more thematic impact models to provide one or more outcome predictions. The particular outcome prediction may be selected in advance by a user or determined based on the type of report being generated. In some embodiments, scoring engines may be arranged to automatically generate one or more reports that include a report (or report information) about a selected theme as well as other report information about one or more related themes or sub-themes.

Next, in one or more of the various embodiments, control may be returned to a calling process.

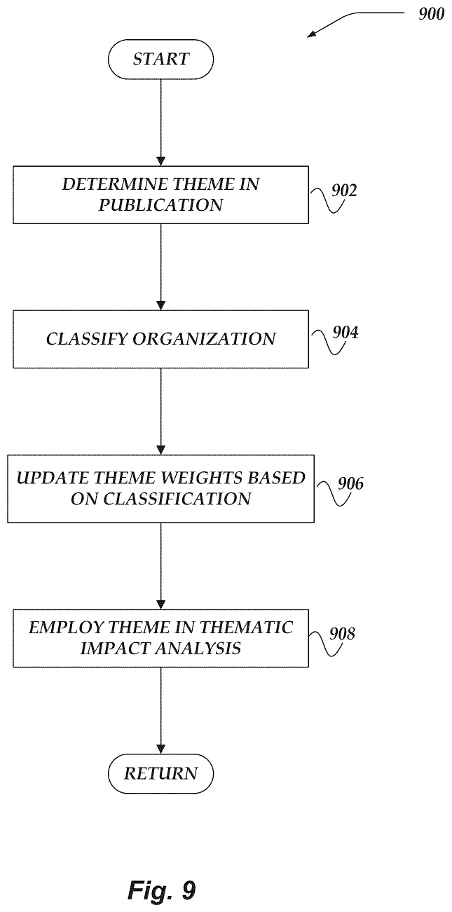

FIG. 9 illustrates a flowchart for process 900 for evaluating investment portfolios based on thematic concepts in accordance with one or more of the various embodiments. After a start block, at block 902, in some embodiments, scoring engines may be arranged to determine a theme mentioned in a publication. As described above, scoring engines or ingestion engines may be arranged to identify one or more theme mentions in individual publications. Note, in some embodiments, ingestion engines may provide one or more metrics associated with theme mentions, including references/pointers to specific mentions in a given publication, indexes or mapping to thematic ontologies or knowledge graphs, or the like. Accordingly, in some embodiments, scoring engines may be arranged to use the information provided by the ingestion engines rather than determining thematic mentions directly. Also, in some embodiments, scoring engines may be arranged to perform some of the actions for determining themes while other information may be provided by ingestion engines or other services.

At block 904, in one or more of the various embodiments, scoring engines may be arranged to classify the organization with respect to the theme. As mentioned above, organizations may be classified as consumers, producers, retailers, or the like, with respect to a given theme. For example, in some embodiments, in this context a consumer organization may be considered an organization that may be relying on another organization to provide items or services associated with the mentioned theme. For example, a publication could include mentions that an organization is making a push to increase its ecommerce presence using a well-known ecommerce store-front provider. Accordingly, in this example, the organization may be designated a consumer of ecommerce services rather than a producer. In some cases, convention NLP techniques may be disadvantageous for determining if thematic mentions indicate if an organization may be a consumer or producer.

Accordingly, in some embodiments, scoring engines may be arranged to generate one or more large language model thematic signatures that include the publication or portions of the publication and a request to predict if the mentioned organization may be a producer of consumer of the theme.

Further, in some embodiments, organizations may be categorized based on geographical location(s), market size, employee count, or the like.

Also, in some embodiments, classification models may be developed to include one or more heuristics, trained machine learning classifiers, as well as submissions to large language models. Also, in some embodiments, scoring engines may be arranged to adapt to discoveries, observations, preferences, or the like, that may introduce or modify criteria for classifying or categorizing organizations. Accordingly, in some embodiments, scoring engines may be arranged to employ rules, instructions, classification models, signature templates, heuristics, or the like, determined based on configuration information to account for local circumstances or local requirements.

At block 906, in one or more of the various embodiments, scoring engines may be arranged to update or modify theme weights, thematic signatures, or the like, based on the classification or category of a given organization. In some embodiments, the particular modifications may be determined as part of generating the thematic models.

At block 908, in one or more of the various embodiments, scoring engines may be arranged to employ the theme mentions in thematic impact analysis for the organization.

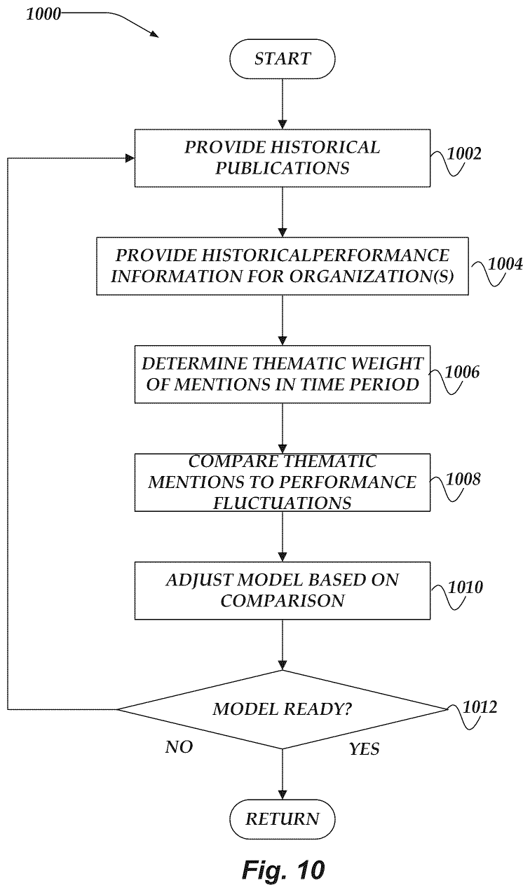

FIG. 10 illustrates a flowchart for process 1000 for generating thematic impact models for evaluating investment portfolios based on thematic concepts in accordance with one or more of the various embodiments. After a start block, at block 1002, in some embodiments, modeling engines may be provided historical publications associated with one or more organizations. In some embodiments, while real-time thematic analysis may employ recent publications, historical publications may be employed to generate thematic impact models. Accordingly, in some embodiments, a corpus of historical publications associated with the organizations, groups of organizations, market segments, market indexes, or the like, may be selected and ingested. In some embodiments, scoring engines may be arranged to maintain running collections of historical publications that may be associated with different historical time windows. For example, in some embodiments, scoring engines may maintain data stores that include publications within the past five years, one year, three months, one month, or the like, for use in generating thematic impact models. Likewise, in some embodiments, historical publication may be organized based on associated organizations, type of publication, source of publication, or the like. Further, in some embodiments, modeling engines may be arranged to select ad-hoc collections of historical publications based on user supplied queries, or the like.

At block 1004, in one or more of the various embodiments, modeling engines may determine historical financial information for the one or more organizations. Similar to how modeling engines may collect historical publication corpus, modeling engines may be arranged to develop collections of historical finance information. In some embodiments, because different thematic impact models may be directed to predicting outcomes for different financial metrics, more than one historical finance information repositories may be generated directed to one or more financial metrics. Further, in some embodiments, modeling engines may be arranged to integrate with one or more external or third-party service that may provide historical information associated with one or more financial metrics. In general, historical publications may be selected to match the same or similar publications that may be intended for use to predict outcomes using the thematic impact models.

At block 1006, in one or more of the various embodiments, modeling engines may be arranged to determine thematic weight of mentions in one or more time periods. As described above, for scoring engines, modeling engines may be arranged to evaluate the thematic mentions included in the historical publications to assign a weight to the thematic mentions included in historical publications.

At block 1008, in one or more of the various embodiments, modeling engines may be arranged to compare the thematic mentions in historical publications to price fluctuations. In some embodiments, modeling engines may be arranged to execute multi-variable analysis to compare how changes to historical financial metrics may correlate with thematic impact. For example, if a prevalence of thematic mentions corresponds to an increase in a financial metric, a hypothesis may be established that the theme and the financial metric may be correlated. Note, the term hypothesis is used because further analysis or iterations may be required to determine if the correlation may be included in a thematic impact model.

At block 1010, in one or more of the various embodiments, modeling engines may be arranged to modify model parameters based on comparison results.

In one or more of the various embodiments, thematic impact models may include various coefficients, included themes, weights, or the like, with varying or different time windows, or the like. Accordingly, in some embodiments, modeling engines may be arranged to iterate over different coefficient ranges, included themes, weights, or the like, to determine thematic impact models that may be effective at predicting outcomes. Accordingly, in some embodiments, modeling engines may be arranged to compare how different ‘versions’ of thematic impact models may predict the actual historical results. In some embodiments, each version of a thematic impact model may be scored against other versions such that modeling engines may generate thematic impact models that converge on making predictions within a configured error range or confidence range.

In some cases, in some embodiments, modeling engines may determine one or more themes that may have no discernible influence on certain predicted outcomes for certain organizations. Accordingly, in some embodiments, modeling engines may be arranged to discover one or more themes that may be omitted from consideration in different circumstances.

At decision block 1012, in one or more of the various embodiments, if the model may be ready for deployment, control may be returned to another process; otherwise, control may loop back to block 1002.

In some embodiments, modeling engines may be arranged to submit thematic mention information derived from a portion of the historical publication repositories to thematic impact models. Accordingly, in some embodiments, if the submission results in predicted outcomes that match the actual historical financial outcomes within a defined error range, the thematic impact models may be considered ready for deployment.

Further, in some embodiments, modeling engines may be arranged to continuously or periodically evaluate deployed thematic impact models. In some embodiments, modeling engines may be arranged to compare thematic impact model outcome predictions based on recent thematic mention information from recent publications with the corresponding actual outcomes. For example, a thematic impact model initially generated based on a year's worth of historical publications may be continuously evaluated based on the most recent publications looking back to a defined time window such as the last 30 days, 14 days, 7 days, 3 days, or the like.

In some embodiments, if thematic impact models may be determined to be unfit, modeling engines may determine one or more thematic concepts, concept weights, or the like, to modify for a next iteration. Accordingly, in some embodiments, modeling engines may be arranged to include safeguards such as iteration count limits, convergence/divergence detectors, or the like, that may determine that a particular thematic impact model may be rejected rather than continuing to iterate across different variables/options.

Next, in one or more of the various embodiments, control may be returned to a calling process.

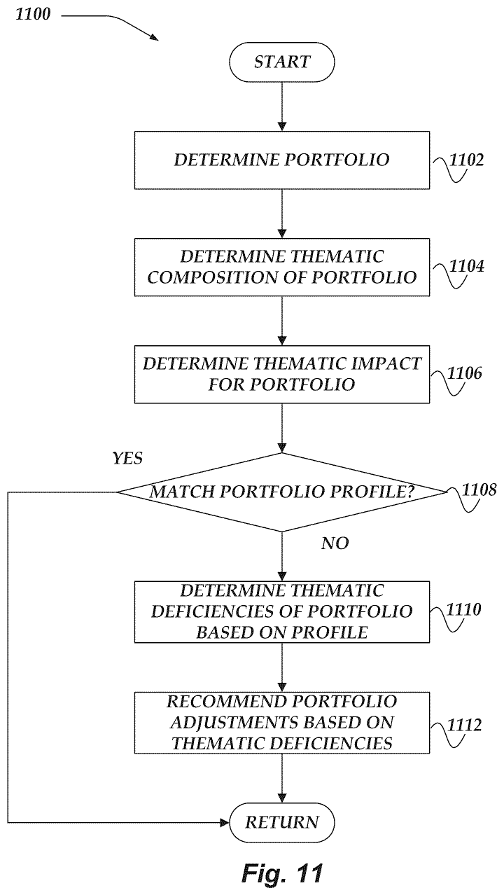

FIG. 11 illustrates a flowchart for process 1100 for evaluating investment portfolios based on thematic concepts in accordance with one or more of the various embodiments. After a start block, at block 1102, in some embodiments, scoring engines may be arranged to determine a portfolio. In some embodiments, scoring engines may be arranged to provide one or more user interfaces that enable users to select a portfolio that includes one or more organizations. In some embodiments, scoring engines may be arranged to user interfaces that enable users select organizations based on themes, as well as one or more conventional parameters, such as market cap, PE ratio, volume, or the like.

In some embodiments, scoring engines may be arranged to enable users to generate portfolio profiles that indicate one or more themes or thematic impacts that may be desirable for a given profile. For example, in some embodiments, a user may be enabled to generate a portfolio profile that declares that particular proportions of the portfolio members or portfolio value should be associated with one or more thematic concepts.

At block 1104, in one or more of the various embodiments, scoring engines may be arranged to determine the thematic composition of the portfolio. As described above, scoring engines may be arranged to determine the thematic composition of individual organizations (e.g., companies) based on an analysis of thematic mentions in current publications. Accordingly, in some embodiments, scoring engines may be arranged to determine thematic composition of portfolios based on the thematic impacts associated with organizations that may be members of the portfolios.

At block 1106, in one or more of the various embodiments, scoring engines may be arranged to determine the thematic impact for the portfolio.

In some embodiments, scoring engines may be configured to allocated thematic impacts of individual portfolio members how an individual contributes to the aggregate value of the portfolio. Note, in most cases, the proportion of contribution to a portfolios' thematic impact score may be based on the proportion of value attributed to individual members. However, in some embodiments, other metrics associated with organization activity, liability, risks, asset holdings, or the like, may be applied to determine how the thematic impacts for an individual member may contribute to the portfolio as a whole.

At decision block 1108, in one or more of the various embodiments, if the portfolio matches its portfolio profile, control may be returned to a calling process; otherwise, control may flow to block 1110. In some embodiments, portfolio profiles may be used to determine if the thematic impacts associated with a portfolio match those desired by a user or administrator. For example, scoring engines may be arranged to enable users to establish personal portfolio profiles that declare the themes and a desired impact such as 20% ecommerce, 10% crypt-currency, 50% technology, 20% agriculture, or the like. Also, for example, scoring engines may provide one or more ‘default’ portfolio profiles that may be used to classify portfolios. For example, a user may provide a portfolio that the scoring engine may classify as technology, consumer goods, natural products, or the like, based on the thematic impacts associated with the organizations included in a given portfolio.

At block 1110, in one or more of the various embodiments, scoring engines may be arranged to determine one or more thematic deficiencies of the portfolio based on the thematic analysis and the portfolio profile. In some embodiments, a portfolio may be designated as deficient if its exposure to a particular thematic concept exceeds a threshold value declared in a portfolio profile. Likewise, in some embodiments, a portfolio may be designated as deficient if its inclusion of a particular thematic concept may be below a threshold value declared in a portfolio profile. Accordingly, in some embodiments, scoring engines may be arranged to determine one or more themes that may be overrepresented or under represented in a given portfolio. In some embodiments, scoring engines may be arranged to generate one or more user interfaces or reports that indicate the particular deficiencies in a portfolio.

At block 1112, in one or more of the various embodiments, scoring engines may be arranged to recommend one or more adjustments to the portfolio based on the thematic deficiencies and the portfolio profile.

Next, in one or more of the various embodiments, control may be returned to a calling process.

It will be understood that each block in each flowchart illustration, and combinations of blocks in each flowchart illustration, can be implemented by computer program instructions. These program instructions may be provided to a processor to produce a machine, such that the instructions, which execute on the processor, create means for implementing the actions specified in each flowchart block or blocks. The computer program instructions may be executed by a processor to cause a series of operational steps to be performed by the processor to produce a computer-implemented process such that the instructions, which execute on the processor, provide steps for implementing the actions specified in each flowchart block or blocks. The computer program instructions may also cause at least some of the operational steps shown in the blocks of each flowchart to be performed in parallel. Moreover, some of the steps may also be performed across more than one processor, such as might arise in a multi-processor computer system. In addition, one or more blocks or combinations of blocks in each flowchart illustration may also be performed concurrently with other blocks or combinations of blocks, or even in a different sequence than illustrated without departing from the scope or spirit of the invention.

Accordingly, each block in each flowchart illustration supports combinations of means for performing the specified actions, combinations of steps for performing the specified actions and program instruction means for performing the specified actions. It will also be understood that each block in each flowchart illustration, and combinations of blocks in each flowchart illustration, can be implemented by special purpose hardware-based systems, which perform the specified actions or steps, or combinations of special purpose hardware and computer instructions. The foregoing example should not be construed as limiting or exhaustive, but rather, an illustrative use case to show an implementation of at least one of the various embodiments of the invention.

Further, in one or more embodiments (not shown in the figures), the logic in the illustrative flowcharts may be executed using an embedded logic hardware device instead of a CPU, such as, an Application Specific Integrated Circuit (ASIC), Field Programmable Gate Array (FPGA), Programmable Array Logic (PAL), or the like, or combination thereof. The embedded logic hardware device may directly execute its embedded logic to perform actions. In one or more embodiments, a microcontroller may be arranged to directly execute its own embedded logic to perform actions and access its own internal memory and its own external Input and Output Interfaces (e.g., hardware pins or wireless transceivers) to perform actions, such as System On a Chip (SOC), or the like.

1. A method for managing data in a network using one or more processors to execute instructions that are configured to cause actions, comprising:
employing natural language processing to determine one or more thematic mentions of concepts in one or more publications, wherein each publication is associated with one or more publication weights associated with an importance or a veracity of each publication;
generating one or more thematic scores associated with the one or more organizations and one or more themes based on two or more concepts corresponding to the one or more thematic mentions and the one or more publication weights;
generating one or more thematic models based on the one organizations and the one or more themes and one or more performance outcomes, wherein the one or more thematic models are trained to generate one or more predicted performance outcomes based on the one or more thematic scores associated with the one or more organizations and the one or more themes;
employing a comparison of the one or more predicted performance outcomes to results for one or more historical performance outcomes to rank an effectiveness of the one or more thematic models, wherein an effectiveness score associated with a thematic model that is outside a range of error is used to modify the one or more thematic models to omit the thematic model outside the range of error;
retraining the one or more modified thematic models having a rank that is within the range of error to predict one or more time windows for occurrence of the one or more predicted performance outcomes for the one or more organizations based on the one or more thematic scores;
generating a user interface with a plurality of localization features to display a report that includes the one or more time windows and the one or more predicted performance outcomes, wherein the plurality localization features are selected to improve one or more of the user interface for the displayed report for a user and a dashboard and an internal process and a database by adding a time zone, a language, a currency, and a calendar format based on geolocation information associated with a computing device employed by the user and provided by one or more geolocation protocols over one or more networks; and
employing one or more additional publications associated with the one or more organizations to cause more actions, including:
retraining the one or more modified thematic models based on one or more other thematic mentions of one or more other concepts included in the one or more additional publications; and
generating another report for display in the user interface with the plurality of selected localization features that includes one or more additional predicted outcomes and one or more additional predicted time windows for each type of additional predicted outcome based on the one or more retrained modified thematic models.

2. The method of claim 1, further comprising:
determining one or more thematic weights of the one or more thematic mentions within the one or more publications based on the natural language processing; and
employing the one or more thematic weights to adjust the one or more thematic scores for each publication.

3. The method of claim 1, further comprising:
generating one or more data structures for one or more thematic signatures that are configured to submit to one or more large language models based on the one or more thematic mentions;
generating one or more responses from the one or more large language models based on a submission of the one or more thematic signatures to a large language model;
classifying one or more portions of the one or more thematic mentions or the one or more organizations as one or more of a consumer mention, a producer mention, or a retail mention, based on the one or more responses;
associating the one or more portions of the one or more thematic mentions or the one or more organizations with a geographical location based on the one or more responses; and
modifying the one or more thematic scores based on one or more of the classification or the association.

4. The method of claim 1, wherein the one or more predicted outcomes include one or more of a revenue value for the one or more organizations, or one or more risk values for the one or more organizations.

5. The method of claim 1, further comprising:
associating one or more other organizations into one or more portfolios;
determining a thematic composition of the one or more portfolios based on one or more other thematic mentions associated with the one or more other organizations;
determining one or more portfolio thematic scores for the one or more portfolios based on one or more other thematic scores associated with each of the one or more other organizations;
comparing the one or more portfolio thematic scores to one or more profiles associated with the one or more portfolios, wherein the one or more profiles declare at least an allocation of one or more themes for each portfolio; and
generate one or more reports that identify one or more deficiencies in the one or more portfolios, wherein each deficiency corresponds to a misallocation of the one or more themes in the one or more portfolios.

6. The method of claim 1, further comprising:
ingesting one or more historical publications associated with the one or more organizations;
determining historical performance information associated with the one or more organizations;
determining one or more historical thematic mentions in the one or more historical publications based on the natural language processing or one or more large language models;
generating one or more candidate thematic models based on the historical performance information and the one or more historical thematic mentions;
employing the one or more candidate thematic models to predict one or more historical outcomes for the one or more organizations; and
comparing the one or more historical outcomes to the historical performance information, wherein each candidate thematic model that predicts a historical outcome that is within an acceptable error range is designated as a thematic model.

7. The method of claim 1, further comprising:
ingesting the one or more publications associated with the one or more organizations;
generating one or more of a knowledge graph, an index, or an ontology that represents one or more themes based on the one or more publications; and
determining the one or more thematic mentions based on the one or more of the knowledge graph, the index, or the ontology.

8. A network computer for managing data, comprising:
a memory that stores at least instructions; and
one or more processors that execute instructions that are configured to cause actions, including:
employing natural language processing to determine one or more thematic mentions of concepts in one or more publications, wherein each publication is associated with one or more publication weights associated with an importance or a veracity of each publication;
generating one or more thematic scores associated with the one or more organizations and one or more themes based on two or more concepts corresponding to the one or more thematic mentions and the one or more publication weights;
generating one or more thematic models based on the one organizations and the one or more themes and one or more performance outcomes, wherein the one or more thematic models are trained to generate one or more predicted performance outcomes based on the one or more thematic scores associated with the one or more organizations and the one or more themes;
employing a comparison of the one or more predicted performance outcomes to results for one or more historical performance outcomes to rank an effectiveness of the one or more thematic models, wherein an effectiveness score associated with a thematic model that is outside a range of error is used to modify the one or more thematic models to omit the thematic model outside the range of error;
retraining the one or more modified thematic models having a rank that is within the range of error to predict one or more time windows for occurrence of the one or more predicted performance outcomes for the one or more organizations based on the one or more thematic scores;
generating a user interface with a plurality of localization features to display a report that includes the one or more time windows and the one or more predicted performance outcomes, wherein the plurality localization features are selected to improve one or more of the user interface for the displayed report for a user and a dashboard and an internal process and a database by adding a time zone, a language, a currency, and a calendar format based on geolocation information associated with a computing device employed by the user and provided by one or more geolocation protocols over one or more networks; and
employing one or more additional publications associated with the one or more organizations to cause more actions, including:
retraining the one or more modified thematic models based on one or more other thematic mentions of one or more other concepts included in the one or more additional publications; and
generating another report for display in the user interface with the plurality of selected localization features that includes one or more additional predicted outcomes and one or more additional predicted time windows for each type of additional predicted outcome based on the one or more retrained modified thematic models.

9. The network computer of claim 8, wherein the one or more processors execute instructions that are configured to cause actions, further comprising:
determining one or more thematic weights of the one or more thematic mentions within the one or more publications based on the natural language processing; and
employing the one or more thematic weights to adjust the one or more thematic scores for each publication.

10. The network computer of claim 8, wherein the one or more processors execute instructions that are configured to cause actions, further comprising:
generating one or more data structures for one or more thematic signatures that are configured to submit to one or more large language models based on the one or more thematic mentions;
generating one or more responses from the one or more large language models based on a submission of the one or more thematic signatures to a large language model;
classifying one or more portions of the one or more thematic mentions or the one or more organizations as one or more of a consumer mention, a producer mention, or a retail mention, based on the one or more responses;
associating the one or more portions of the one or more thematic mentions or the one or more organizations with a geographical location based on the one or more responses; and
modifying the one or more thematic scores based on one or more of the classification or the association.

11. The network computer of claim 8, wherein the one or more predicted outcomes include one or more of a revenue value for the one or more organizations, or one or more risk values for the one or more organizations.

12. The network computer of claim 8, wherein the one or more processors execute instructions that are configured to cause actions, further comprising:
associating one or more other organizations into one or more portfolios;
determining a thematic composition of the one or more portfolios based on one or more other thematic mentions associated with the one or more other organizations;
determining one or more portfolio thematic scores for the one or more portfolios based on one or more other thematic scores associated with each of the one or more other organizations;
comparing the one or more portfolio thematic scores to one or more profiles associated with the one or more portfolios, wherein the one or more profiles declare at least an allocation of one or more themes for each portfolio; and
generate one or more reports that identify one or more deficiencies in the one or more portfolios, wherein each deficiency corresponds to a misallocation of the one or more themes in the one or more portfolios.

13. The network computer of claim 8, wherein the one or more processors execute instructions that are configured to cause actions, further comprising:
ingesting one or more historical publications associated with the one or more organizations;
determining historical performance information associated with the one or more organizations;
determining one or more historical thematic mentions in the one or more historical publications based on the natural language processing or one or more large language models;
generating one or more candidate thematic models based on the historical performance information and the one or more historical thematic mentions;
employing the one or more candidate thematic models to predict one or more historical outcomes for the one or more organizations; and
comparing the one or more historical outcomes to the historical performance information, wherein each candidate thematic model that predicts a historical outcome that is within an acceptable error range is designated as a thematic model.

14. The network computer of claim 8, wherein the one or more processors execute instructions that are configured to cause actions, further comprising:
ingesting the one or more publications associated with the one or more organizations;
generating one or more of a knowledge graph, an index, or an ontology that represents one or more themes based on the one or more publications; and
determining the one or more thematic mentions based on the one or more of the knowledge graph, the index, or the ontology.

15. A processor readable non-transitory storage media that includes instructions configured for managing data, wherein execution of the instructions by one or more processors on one or more network computers causes performance of actions, comprising:
employing natural language processing to determine one or more thematic mentions of concepts in one or more publications, wherein each publication is associated with one or more publication weights associated with an importance or a veracity of each publication;
generating one or more thematic scores associated with the one or more organizations and one or more themes based on two or more concepts corresponding to the one or more thematic mentions and the one or more publication weights;
generating one or more thematic models based on the one organizations and the one or more themes and one or more performance outcomes, wherein the one or more thematic models are trained to generate one or more predicted performance outcomes based on the one or more thematic scores associated with the one or more organizations and the one or more themes;
employing a comparison of the one or more predicted performance outcomes to results for one or more historical performance outcomes to rank an effectiveness of the one or more thematic models, wherein an effectiveness score associated with a thematic model that is outside a range of error is used to modify the one or more thematic models to omit the thematic model outside the range of error;
retraining the one or more modified thematic models having a rank that is within the range of error to predict one or more time windows for occurrence of the one or more predicted performance outcomes for the one or more organizations based on the one or more thematic scores;
generating a user interface with a plurality of localization features to display a report that includes the one or more time windows and the one or more predicted performance outcomes, wherein the plurality localization features are selected to improve one or more of the user interface for the displayed report for a user and a dashboard and an internal process and a database by adding a time zone, a language, a currency, and a calendar format based on geolocation information associated with a computing device employed by the user and provided by one or more geolocation protocols over one or more networks; and
employing one or more additional publications associated with the one or more organizations to cause more actions, including:
retraining the one or more modified thematic models based on one or more other thematic mentions of one or more other concepts included in the one or more additional publications; and
generating another report for display in the user interface with the plurality of selected localization features that includes one or more additional predicted outcomes and one or more additional predicted time windows for each type of additional predicted outcome based on the one or more retrained modified thematic models.

16. The media of claim 15, further comprising:
determining one or more thematic weights of the one or more thematic mentions within the one or more publications based on the natural language processing; and
employing the one or more thematic weights to adjust the one or more thematic scores for each publication.

17. The media of claim 15, further comprising:
generating one or more data structures for one or more thematic signatures that are configured to submit to one or more large language models based on the one or more thematic mentions;
generating one or more responses from the one or more large language models based on a submission of the one or more thematic signatures to a large language model;
classifying one or more portions of the one or more thematic mentions or the one or more organizations as one or more of a consumer mention, a producer mention, or a retail mention, based on the one or more responses;
associating the one or more portions of the one or more thematic mentions or the one or more organizations with a geographical location based on the one or more responses; and
modifying the one or more thematic scores based on one or more of the classification or the association.

18. The media of claim 15, wherein the one or more predicted outcomes include one or more of a revenue value for the one or more organizations, or one or more risk values for the one or more organizations.

19. The media of claim 15, further comprising:
associating one or more other organizations into one or more portfolios;
determining a thematic composition of the one or more portfolios based on one or more other thematic mentions associated with the one or more other organizations;
determining one or more portfolio thematic scores for the one or more portfolios based on one or more other thematic scores associated with each of the one or more other organizations;
comparing the one or more portfolio thematic scores to one or more profiles associated with the one or more portfolios, wherein the one or more profiles declare at least an allocation of one or more themes for each portfolio; and
generate one or more reports that identify one or more deficiencies in the one or more portfolios, wherein each deficiency corresponds to a misallocation of the one or more themes in the one or more portfolios.

20. The media of claim 15, further comprising:
ingesting one or more historical publications associated with the one or more organizations;
determining historical performance information associated with the one or more organizations;
determining one or more historical thematic mentions in the one or more historical publications based on the natural language processing or one or more large language models;
generating one or more candidate thematic models based on the historical performance information and the one or more historical thematic mentions;
employing the one or more candidate thematic models to predict one or more historical outcomes for the one or more organizations; and
comparing the one or more historical outcomes to the historical performance information, wherein each candidate thematic model that predicts a historical outcome that is within an acceptable error range is designated as a thematic model.

21. The media of claim 15, further comprising:
ingesting the one or more publications associated with the one or more organizations;
generating one or more of a knowledge graph, an index, or an ontology that represents one or more themes based on the one or more publications; and
determining the one or more thematic mentions based on the one or more of the knowledge graph, the index, or the ontology.

22. A system for managing data:
one or more network computers, comprising:
a memory that stores at least instructions; and
one or more processors that execute instructions that are configured to cause actions, including:
employing natural language processing to determine one or more thematic mentions of concepts in one or more publications, wherein each publication is associated with one or more publication weights associated with an importance or a veracity of each publication;
generating one or more thematic scores associated with the one or more organizations and one or more themes based on two or more concepts corresponding to the one or more thematic mentions and the one or more publication weights;
generating one or more thematic models based on the one organizations and the one or more themes and one or more performance outcomes, wherein the one or more thematic models are trained to generate one or more predicted performance outcomes based on the one or more thematic scores associated with the one or more organizations and the one or more themes;
employing a comparison of the one or more predicted performance outcomes to results for one or more historical performance outcomes to rank an effectiveness of the one or more thematic models, wherein an effectiveness score associated with a thematic model that is outside a range of error is used to modify the one or more thematic models to omit the thematic model outside the range of error;
retraining the one or more modified thematic models having a rank that is within the range of error to predict one or more time windows for occurrence of the one or more predicted performance outcomes for the one or more organizations based on the one or more thematic scores;
generating a user interface with a plurality of localization features to display a report that includes the one or more time windows and the one or more predicted performance outcomes are displayed in a report, wherein the plurality localization features are selected to improve one or more of the user interface for the displayed report for a user and a dashboard and an internal process and a database by adding a time zone, a language, a currency, and a calendar format based on geolocation information associated with a computing device employed by the user and provided by one or more geolocation protocols over one or more networks; and
employing one or more additional publications associated with the one or more organizations to cause more actions, including:
retraining the one or more modified thematic models based on one or more other thematic mentions of one or more other concepts included in the one or more additional publications; and
generating another report for display in the user interface with the plurality of selected localization features that includes one or more additional predicted outcomes and one or more additional predicted time windows for each type of additional predicted outcome based on the one or more retrained modified thematic models; and
one or more client computers, comprising:
a memory that stores at least instructions; and
one or more processors that execute instructions that are configured to cause actions, including:
displaying one or more of the report or the other report.

23. The system of claim 22, wherein the one or more processors of the one or more network computers execute instructions that are configured to cause actions, further comprising:
determining one or more thematic weights of the one or more thematic mentions within the one or more publications based on the natural language processing; and
employing the one or more thematic weights to adjust the one or more thematic scores for each publication.

24. The system of claim 22, wherein the one or more processors of the one or more network computers execute instructions that are configured to cause actions, further comprising:
generating one or more data structures for one or more thematic signatures that are configured to submit to one or more large language models based on the one or more thematic mentions;
generating one or more responses from the one or more large language models based on a submission of the one or more thematic signatures to a large language model;
classifying one or more portions of the one or more thematic mentions or the one or more organizations as one or more of a consumer mention, a producer mention, or a retail mention, based on the one or more responses;
associating the one or more portions of the one or more thematic mentions or the one or more organizations with a geographical location based on the one or more responses; and
modifying the one or more thematic scores based on one or more of the classification or the association.

25. The system of claim 22, wherein the one or more predicted outcomes include one or more of a revenue value for the one or more organizations, or one or more risk values for the one or more organizations.

26. The system of claim 22, wherein the one or more processors of the one or more network computers execute instructions that are configured to cause actions, further comprising:
associating one or more other organizations into one or more portfolios;
determining a thematic composition of the one or more portfolios based on one or more other thematic mentions associated with the one or more other organizations;
determining one or more portfolio thematic scores for the one or more portfolios based on one or more other thematic scores associated with each of the one or more other organizations;
comparing the one or more portfolio thematic scores to one or more profiles associated with the one or more portfolios, wherein the one or more profiles declare at least an allocation of one or more themes for each portfolio; and
generate one or more reports that identify one or more deficiencies in the one or more portfolios, wherein each deficiency corresponds to a misallocation of the one or more themes in the one or more portfolios.

27. The system of claim 22, wherein the one or more processors of the one or more network computers execute instructions that are configured to cause actions, further comprising:
ingesting one or more historical publications associated with the one or more organizations;
determining historical performance information associated with the one or more organizations;
determining one or more historical thematic mentions in the one or more historical publications based on the natural language processing or one or more large language models;
generating one or more candidate thematic models based on the historical performance information and the one or more historical thematic mentions;
employing the one or more candidate thematic models to predict one or more historical outcomes for the one or more organizations; and
comparing the one or more historical outcomes to the historical performance information, wherein each candidate thematic model that predicts a historical outcome that is within an acceptable error range is designated as a thematic model.

28. The system of claim 22, wherein the one or more processors of the one or more network computers execute instructions that are configured to cause actions, further comprising:
ingesting the one or more publications associated with the one or more organizations;
generating one or more of a knowledge graph, an index, or an ontology that represents one or more themes based on the one or more publications; and
determining the one or more thematic mentions based on the one or more of the knowledge graph, the index, or the ontology.
